(19) United States
(12) Patent Application Publication
(10) Pub. No.: US 2025/0097231 A1
(43) Pub. Date: Mar. 20, 2025

(54) FILE SERVER MANAGERS INCLUDING API-LEVEL PERMISSIONS EXAMINATION

(71) Applicant: Nutanix, Inc., San Jose, CA (US)

(72) Inventors: David Lai, Santa Clara, CA (US); Mausumi Ranasingh, San Jose, CA (US); Kalpesh Ashok Bafna, Fremont, CA (US)

(21) Appl. No.: 18/468,558

(22) Filed: Sep. 15, 2023

(51) Int. Cl. H04L 9/40; H04L 67/06

(52) U.S. Cl. CPC H04L 63/102; H04L 63/105; H04L 67/06

(57) ABSTRACT

Examples of file server managers are described herein. A file server manager may be in communication with one or more virtualized file servers and may be used to provide a single pane of glass management interface to the virtualized file servers. File server managers described herein may include gateways and may examine API-level permissions for received API calls. File server managers may route API calls to target virtualized file servers. Role-based access permissions implemented by file server managers are also described.

### TECHNICAL FIELD

Examples described herein relate generally to virtualized environments. Examples of file server managers are described which may communicate with one or more virtualized, distributed file servers. The virtualized, distributed file servers may each host a file system accessible to the file server manager.

### BACKGROUND

Enterprises increasingly utilize multiple computing systems to store and manage the data of the organization. The systems utilized may include a number of virtualized systems on any number of hardware platforms. It may be increasingly cumbersome for an enterprise to manage these varied systems. For example, when virtualized systems are involved, it may be cumbersome to maintain and manage multiple virtualized systems—for example, to add, subtract, and/or modify virtual machines in the virtualized systems and/or to move data as needed in the virtualized system.

### BRIEF DESCRIPTION OF THE DRAWINGS

FIG. 1 is a schematic illustration of a system arranged in accordance with examples described herein.

FIG. 2 is a schematic illustration of a process arranged in accordance with examples described herein.

FIG. 3 is an example user interface arranged in accordance with examples described herein.

FIG. 4 is a schematic illustration of a clustered virtualization environment 400 implementing a virtualized file server in accordance with examples described herein.

FIG. 5 is a schematic illustration of a clustered virtualization environment 500 arranged in accordance with examples described herein.

FIG. 6 illustrates an example hierarchical structure of a VFS instance in a cluster according to particular embodiments.

FIG. 7 illustrates two example host machines, each providing file storage services for portions of two VFS instances FS1 and FS2 according to particular embodiments.

FIG. 8 illustrates example interactions between a client and host machines on which different portions of a VFS instance are stored according to particular embodiments.

FIG. 9 is a schematic illustration of a computing system arranged in accordance with examples described herein.

### DETAILED DESCRIPTION

Certain details are set forth herein to provide an understanding of described embodiments of technology. However, other examples may be practiced without various of these particular details. In some instances, well-known computing system components, virtualization technology or operations, and/or software operations have not been shown in detail in order to avoid unnecessarily obscuring the described embodiments. Other embodiments may be utilized, and other changes may be made, without departing from the spirit or scope of the subject matter presented here.

Examples described herein include file server managers which may manage multiple virtualized file servers. The multiple virtualized file servers managed by a file server manager may be hosted by multiple computing node clusters (e.g., in multiple virtualization environments). The file server manager may be in communication with each of the multiple virtualized file servers. In this manner, a file server manager may provide a single pane of glass management interface to help manage and orchestrate file platform and service specific operations from a single location (e.g., a single logon and/or single user interface). File server managers may accordingly implement policies and conduct other operations based on data from multiple virtualized file servers in communication with the file server manager.

In some examples, the file server manager may perform user management for users that may send, receive, or otherwise access application programming interface (API) calls for the file servers managed by the file server manager. The file server manager may act as a demultiplexer and forward APIs to their respective target file servers. If the API call pertains to operations performed externally to the file server—e.g., deployment of a new file server, upgrading the file server, assigning one or more new Internet Protocol (IP) addresses to the file server, and/or policy creation such as for disaster recovery or synchronization, the operations responsive to the API call may be performed by the file server manager itself. API calls that call for operations that may be performed within the file server may be forwarded to the file server. In this manner, the file server manager may front-end the API calls for all file servers managed by (e.g., registered with) the file server manager, as well as API calls to be processed by the file server manager and/or admin system. The file server manager may proxy and process the API calls either for use by the file server manager, admin system, and/or file servers. The file server manager may correctly process multiple versions of the APIs and multiple versions of managed file servers. Users may have a single credential for all APIs irrespective of the multiple versions of the managed file servers.

When managing multiple file servers, it can be cumbersome to maintain or enforce accurate permissions for operations relating to the file servers and/or file server manager. Examples described herein include systems and methods which allow applications to direct API requests to a single control plane—e.g., a file server manager. The file server manager may determine which managed file server is the target of the API call. The file server manager may route the API call to the appropriate file server.

Accordingly, the file server manager may provide a centralized place to implement role-based access. Users (e.g., clients) which may send API requests to the file server manager may be associated with a role. API-level permissions may be associated with the role, and imparted to the user by virtue of the user's association with the role.

API-level permissions generally relate to permissions to execute particular API calls. The API calls may relate, for example, to file server operations—e.g., creating one or more shares, scaling out a file server, setting file server policies, etc. API-level permissions are generally different than file permissions (e.g., access control lists (ACLs)) which pertain to whether users have rights to view and/or edit particular data. The API-level permissions relate to operations and API calls rather than data access.

Examples of file server managers are described herein. A file server manager may be in communication with one or more virtualized file servers and may be used to provide a single pane of glass management interface to the virtualized file servers. File server managers described herein may include gateways and may examine API-level permissions for received API calls. File server managers may route API calls to target virtualized file servers. Role-based access permissions implemented by file server managers are also described.

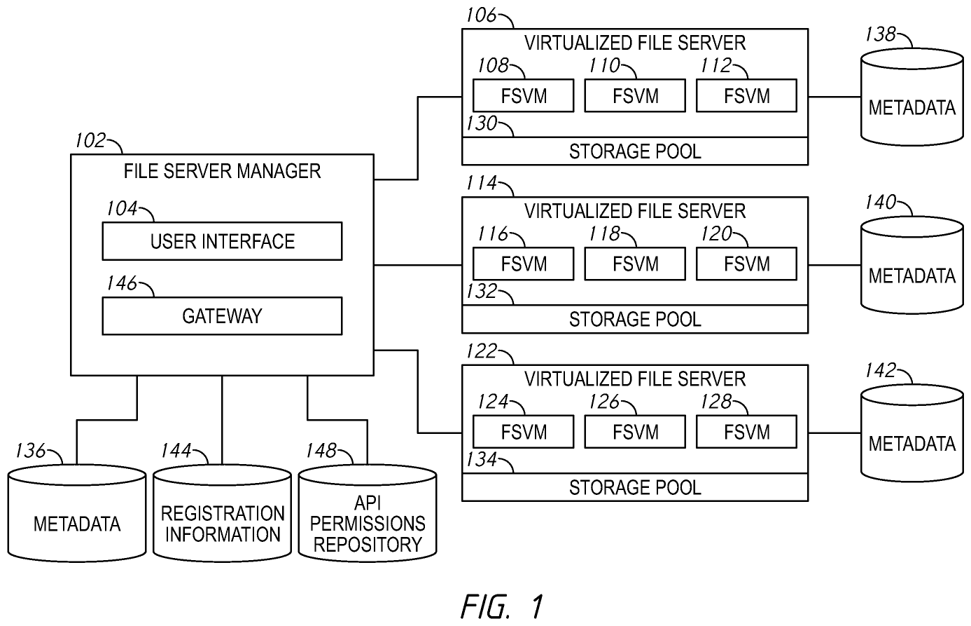

FIG. 1 is a schematic illustration of a system arranged in accordance with examples described herein. The system of FIG. 1 includes file server manager 102. The file server manager 102 may provide user interface 104. The file server manager 102 may be in communication with memory and/or storage for metadata 136, registration information 144, and API permissions repository 148. The file server manager 102 may include gateway 146. The system of FIG. 1 further includes virtualized file server 106, virtualized file server 114, and virtualized file server 122. The virtualized file server 106, virtualized file server 114, and virtualized file server 122 may each be in communication with the file server manager 102 (e.g., over one or more networks). Each of the virtualized file server 106, virtualized file server 114, and virtualized file server 122 may be hosted in a same and/or different virtualization environment. Each of the virtualized file server 106, virtualized file server 114, and virtualized file server 122 may include a cluster of computing nodes hosting a cluster of file server virtual machines (FSVM). For example, the virtualized file server 106 includes FSVM 108, FSVM 110, and FSVM 112. The virtualized file server 114 includes FSVM 116, FSVM 118, and FSVM 120. The virtualized file server 122 includes FSVM 124, FSVM 126, and FSVM 128. Each of the virtualized file server 106, virtualized file server 114, and virtualized file server 122 may include a storage pool. For example, the virtualized file server 106 may include storage pool 130, the virtualized file server 114 may include storage pool 132, and the virtualized file server 122 may include storage pool 134. Moreover, each of the virtualized file server 106, virtualized file server 114, and virtualized file server 122 may include storage and/or memory for storing metadata. The virtualized file server 106 may store metadata 138. The virtualized file server 114 may store metadata 140. The virtualized file server 122 may store metadata 142.

The components shown in FIG. 1 are exemplary only. Additional, fewer, and/or different components may be used in other examples. For example, three virtualized file servers are depicted in FIG. 1, however any number may be used and may be in communication with the file server manager 102. While virtual machines are shown in FIG. 1, it is to be understood that any virtualizing technology may be used to implement the FSVMs shown in FIG. 1, such as containers. Accordingly, any FSVM shown or described herein may be implemented using a container in some examples.

Examples of systems described herein may accordingly include one or more virtualized file servers, such as virtualized file server 106, virtualized file server 114, and virtualized file server 122 in FIG. 1. A virtualized file server may represent a logical entity in the system. Virtualized file servers described herein may be hosted in generally any virtualization environment (e.g., on generally any virtualization platform). The virtualization environment and/or platform generally refers to the storage resources that have been virtualized by the virtualized file server and the compute resources (e.g., computing nodes with processor(s)) used to manage the virtualized storage. For example, the virtualized file server 106 may be hosted on a different virtualization environment than the virtualized file server 114 and/or than the virtualized file server 122. Nonetheless, in some examples one or more virtualized file servers in communication with a file server manager may be hosted in a same virtualization environment. Examples of virtualization environments include, for example, on premises installations of one or more computing nodes and storage devices. Examples of virtualization environment include one or more cloud computing systems (e.g., Amazon Web Services, MICROSOFT AZURE). Although not shown explicitly in FIG. 1, virtualization environments and/or virtualized file servers may include additional components including, but not limited to, one or more hypervisors, storage controllers, operating systems, containers, and/or container orchestrators (e.g., Kubernetes). The multiple virtualized file servers in communication with a file server manager described herein may in some examples be located in different geographic locations (e.g., different buildings, states, cities, or countries). The multiple virtualized file servers in communication with a file server manager may in some examples be utilizing different versions of file system and/or file server software.

A virtualized file server may include a cluster of virtual machines and/or other virtualized entities (e.g., containers), which may be referred to as file server virtual machines (FSVMs). In some examples, each of the FSVMs of a cluster may be implemented on different computing nodes forming a computing node cluster. For example, the FSVM 108, FSVM 110, and FSVM 112 of virtualized file server 106 may each be implemented on separate computing nodes of a computing node cluster used by the virtualized file server 106. Similarly, the FSVM 116. FSVM 118, and FSVM 120 may each be implemented on separate computing nodes of a computing node cluster used by the virtualized file server 114. Similarly, the FSVM 124, FSVM 126, and FSVM 128 may each be implemented on separate computing nodes of a computing nodes cluster used by the virtualized file server 122. In some examples, a cluster of FSVMs may be implemented on a cloud computing system.

The FSVMs may operate to provide a file system on the storage resources of the virtualized file server (e.g., the storage pool). The file system may have a single namespace and may store data in accordance with filenames and/or directories. The FSVMs may accordingly support one or more file system protocols, such as Network Filesystem (NFS) and/or Server Message Block (SMB). A virtualized file server (such as virtualized file server 106, virtualized file server 114, and/or virtualized file server 122) may translate file system protocol requests for one or more files and/or directories (e.g., a file path) into one or more storage requests to access the data corresponding to the file, directory, and/or file path. Any of a variety of components of the virtualized file server may be used to perform the translation (e.g., one or more FSVMs, one or more hypervisors, and/or one or more storage controllers). The translation may be performed using a map (e.g., a shard map) relating the location of the data to the file name, share, directory, and/or file path.

Virtualized file servers described herein may be used to access a storage pool. For example, the virtualized file server 106 may access storage pool 130. The virtualized file server 114 may access storage pool 132. The virtualized file server 122 may access storage pool 134. The storage pool may generally include any number or kind of storage devices—for example, network-attached storage, local storage of one or more computing nodes forming the virtualized file server, and/or cloud storage. Storage devices may be implemented using, for example one or more memories, hard disk drives, and/or solid state drives. The storage for a particular virtualized file server may be referred to as a storage pool. The storage may be arranged in one or more shares. In some examples, each file server virtual machine (FSVM) may manage (e.g., host) a corresponding share or portion of a share. A shard map may store associations between shares and files, directories, and/or file paths.

Virtualized file servers described herein may include metadata. For example, virtualized file server 106 may include metadata 138. The virtualized file server 114 may include metadata 140. The virtualized file server 122 may include metadata 142. The metadata may be stored, for example, in the storage pool and/or other storage location accessible to the virtualized file server. The metadata may in some examples be distributed across the storage pool of a virtualized file server. In some examples, the metadata may be stored in a database accessible to and/or hosted by the virtualized file server. Metadata stored by a virtualized file server may include, for example, authentication information for the virtualized file server and/or virtual machines in the virtualized file server, authorization information for the virtualized file server and/or virtual machines in the virtualized file server, configuration information for the virtualized file server and/or virtual machines in the virtualized file server, end point information (e.g., supported API calls and/or endpoints), a number of shares stored in the virtualized storage of the virtualized file server, a protocol supported by each share and/or FSVM (e.g., NFS and/or SMB), identities of the shares stored in the virtualized storage of the virtualized file server, a number of file server virtual machines (FSVMs) present in the virtualized file server, a number of files and/or directories hosted by the virtualized file server, compute resources available and/or used at the virtualized file server, storage resources available and/or used at the virtualized file server, an IP address for the virtualized file server and/or IP addresses of FSVMs in the virtualized file server, versions of software (e.g., FSVMs) used to form the virtualized file server, and/or other metadata regarding the virtualized file server. The metadata may be maintained by the virtualized file server, for example, the metadata may be updated as the number of shares, FSVMs, storage resources and/or compute resources change.

Examples described herein may include a file server manager, such as file server manager 102 of FIG. 1. A file server manager may be in communication with multiple virtualized file servers. For example, the file server manager 102 may be in communication with virtualized file server 106, virtualized file server 114, and virtualized file server 122. In this manner, the file server manager 102 may allow for access to, maintenance of, and/or management of multiple virtualized file servers (e.g., multiple file systems). An enterprise may have many virtualized file servers that are desired to be managed—for example, different geographic locations of the enterprise may maintain separate file systems and/or implement different privacy or other data policies. In some examples, different departments or entities within an organization may maintain respective virtualized file servers. An administrator or other entity associated with the enterprise, such as an IT manager, may advantageously view, access, and/or manage multiple virtualized file servers using the file server manager (e.g., file server manager 102). The file server manager may communicate with each virtualized file server using any of a variety of connections, including one or more networks. In some examples, a same network may be used to communicate between the file server manager and multiple virtualized file servers. In some examples, multiple networks may be used.

File server managers, such as file server manager 102 of FIG. 1 may be implemented using one or more computing devices. In some examples, an administrative computing system may be used. The administrative computing system may include, for example, one or more processors and non-transitory computer-readable media encoded with instructions for performing the file server manager operations described herein. In some examples, the file server manager may be implemented using a computing device different than the computing devices (e.g., computing nodes) used to implement the virtualized file server(s) with which the file server manager is in communication. In some examples, the file server manager may be hosted on one of the computing nodes forming a part of a virtualized file server in communication with the file server manager. File server managers, such as file server manager 102, may be hosted on permises systems in some examples, and/or on cloud computing systems in some examples.

Examples of file server managers described herein may provide one or more user interfaces, such as user interface 104 of FIG. 1. The user interface may allow a user (e.g., a human administrator and/or another computer process) to view information regarding multiple virtualized file servers, to communicate with multiple virtualized file servers, to manage multiple virtualized file servers, and generally to offer a single pane of glass interface to the multiple virtualized file servers in communication with the file server manager. The user interface may be implemented, for example, using one or more communications interface(s), display(s) and/or one or more input and/or output device(s) (e.g., mouse, keyboard, touchscreen, etc.). In some examples, user interface 104 of file server manager 102 may be used to depict one or more of the virtualized file server 106, virtualized file server 114, and/or virtualized file server 122. For example, the identity and number of shares used by the virtualized file servers may be displayed. In some examples, the number and identity of computing nodes and/or FSVMs in each of the virtualized file servers may be displayed. Other attributes of the virtualized file servers may additionally or instead be displayed using a user interface of a file server manager. The data used in the display may wholly and/or partially be obtained from the registration information and/or metadata synchronized with one or more of the virtualized file servers.

Examples of file server managers described herein may include one or more gateways, such as gateway 146 of FIG. 1. The gateway 146 may be implemented using executable instructions stored on a computer-readable media and executed by one or more processors of the file server manager 102. In some examples, the gateway 146 may be implemented using a containerized service. In some examples, the gateway 146 may be implemented wholly or partially in hardware, e.g., circuitry for performing the gateway operations described herein. The gateway 146 may facilitate routing of API calls received by the file server manager 102 to one or more target file servers—e.g., virtualized file server 106, virtualized file server 114, and/or virtualized file server 122 in the example of FIG. 1. The gateway 146 may utilize an identification of a target virtualized file server (e.g., name, uniform resource locator (URL), uniform resource indicator (URI), or other identification). The gateway 146 may utilize the identification of the target virtualized file server to route API calls to the target file server. The gateway 146 may identify a virtual IP address of each managed file server using an identification of the file server, which may, for example, be stored in registration information 144.

Examples of file server managers described herein may store registration information, such as registration information 144 of FIG. 1. The registration information 144 may include information regarding each virtualized file server in communication with the file server manager 102. The registration information 144 may include information used to manage, communicate with, and/or otherwise interact with the virtualized file server. Examples of registration information include a name of the virtualized file server, an identification of the virtualization environment hosting the virtualized file server, credentials for one or more FSVMs in the virtualized file server, IP addresses or other addresses for the virtualized file server, FSVMs in the virtualized file server, or other components of the virtualized file server. During setup of a system including a file server manager, the virtualized file servers may be registered with the file server manager, and may provide registration information to the file server manager. The registration information may be stored by the file server manager, such as in registration information 144, which may be a database in some examples. The registration information may be stored on a memory and/or other storage device accessible to the file server manager.

In some examples, the registration information 144 may include information regarding users of the file servers registered with the file server manager. For example, an identification number and user name may be provided for each user of a particular file server. In some examples, the user information may be provided to the file server manager from a directory, such as an active directory and/or Lightweight Directory Access Protocol (LDAP). The directory may be used by the file server to operate the file server—e.g., to grant or deny access to particular files and/or shares. Note that, in this manner, the registration information 144 may include user directory information for multiple managed file servers in a single repository.

Examples of file server managers described herein may include metadata, such as metadata 136. The metadata may be synchronized to the metadata of multiple virtualized file servers in communication with the file server manager. For example, the metadata 136 may be synchronized with metadata 138, metadata 140, and metadata 142. For example, the metadata 136 at any given time may include metadata 138, metadata 140, and metadata 142. Synchronization may be maintained over time—the metadata of multiple virtualized file servers may periodically (e.g., at regular and/or irregular intervals) synchronize with the metadata store of the file server manager. In this manner, the file server manager 102 may maintain an updated storage of metadata associated with each of virtualized file server 106, virtualized file server 114, and virtualized file server 122. The metadata may be accessed by the file server manager and used to manage, communicate with, and/or otherwise interact with the virtualized file servers.

Examples of file server managers described herein may have access to an API permissions repository, such as API permissions repository 148 of FIG. 1. The API permissions repository may be stored on storage and/or memory devices in communication with the file server manager 102. The API permissions repository may include information regarding the API permissions for users of each of the file servers registered with the file server manager 102—e.g., virtualized file server 106, virtualized file server 114, and virtualized file server 122 in the example of FIG. 1. The API permissions may include an indication of whether each user may submit particular API calls. Examples of API calls include those used to manage file servers such as create a new share, scale out the file server, or set a disaster recovery, replication, or other policy. In some examples the API permissions repository may store a role associated with one or more of the users. The role may in turn be associated with a set of API permissions.

While the metadata 136, registration information 144, and API permissions repository 148 are depicted separately in FIG. 1, they may be wholly and/or partially stored on a same storage device in some examples. The metadata 136 may be stored, for example, in a database. The registration information 144 may be stored, for example, in a database. The API permissions repository 148 may be stored, for example, in a database. Any of a variety of database synchronization techniques may be used to synchronize the metadata of the file server manager with the metadata of multiple virtualized file servers. In some examples, the API permissions repository 148 may be integrated with the registration information 144.

During operation, a file server manager described herein may register, such as by receiving a registration for, one or more virtualized file servers. For example, a virtualized file server (e.g., using an FSVM, a hypervisor, and/or another component of the virtualized file server), may transmit a registration (e.g., registration information) to the file server manager. In some examples, the file server manager may request such a registration by transmitting a request to register to the virtualized file server. In some examples, such as when the file server manager is hosted on a cluster and/or within a same system as the virtualized file server, an automatic registration may occur. For example, the registration process may include determining (e.g., from one or more IP addresses used), that a virtualized file server is hosted on a same domain as a file server manager. In other examples, virtualized file servers which are not hosted on a same domain as a file server manager may nonetheless register with the file server manager. In the example of FIG. 1, the file server manager 102 may request registration from virtualized file server 106, virtualized file server 114, and virtualized file server 122. For example, a system administrator may enter an IP address, name, or other identifier to request a registration from virtualized file server 106, virtualized file server 114, and/or virtualized file server 122. In some examples, a system administrator or other user or component may transmit a registration from virtualized file server 106, virtualized file server 114, and/or virtualized file server 122, which registration may or may not be responsive to a request. In some examples, the operating system of one or more computing nodes of the virtualized file server hosting an FSVM may provide a registration request to the file server manager. The registration may include registration information which file server manager 102 may store in registration information 144.

The file server manager may synchronize metadata of registered file servers such that up to date metadata of the registered file server may be accessible to the file server manager. For example, the metadata 136 may synchronize with metadata 138, metadata 140, and metadata 142 of FIG. 1. Any and/or all types of metadata of a virtualized file server may be synched with a file server manager. For example, a number and identity of shares of each virtualized file server may be synchronized with the file server manager. In some examples, compute and/or storage resource usage may additionally or instead be synchronized between a virtualized file server and the file server manager. Sharding or other maps and/or portions thereof may be synchronized between a virtualized file server and the file server manager. Other metadata may be synchronized additionally or instead.

During operation, file server managers described herein, such as file server manager 102 of FIG. 1 may receive a management request for a particular virtualized file server. The management request may be received, for example by a client which may be hosted on a client system, on a system also hosting the file server manager, and/or on a system hosting all or a portion of one of the virtualized file servers in communication with the file server manager. In some examples, the management request may be implemented using an API call. The gateway 146 may provide an API endpoint to receive API calls for one or more virtualized file servers. Examples of management requests include requests for accessing, managing, and/or maintaining the virtualized file server. For example, a management request may be a request to add and/or subtract one or more FSVMs, add and/or subtract one or more shares in the storage, and/or upgrade one or more FSVMs.

The file server manager may format the received management request for the virtualization environment (e.g., virtualization platform) used to host the requested virtualized file server. For example, the file server manager may access the registration information 144 to identify a virtualization environment for a virtualized file server identified in the management request. The management request may then be formatted in a manner used by the virtualized environment. In some examples, the formatted management request may be implemented as an API call, with the API call specific to the virtualization environment of the target virtualized file server. In this manner, clients or other users providing management requests to the file server manager may not require knowledge of the virtualized environment hosting the virtualized file server. The file server manager may format the request in the manner used to communicate with the appropriate virtualization environment. This may provide flexibility in system design and usage, as multiple virtualization environments may be used, and virtualized file servers may in some examples be relocated from one virtualized environment to another without a need to update management requests being provided to the file server manager. Instead, an updated identification of the virtualized environment may be stored in, for example, registration information 144 and/or metadata 136.

Additionally or instead, the file server manager may format the received management request for one or more versions of software present in the target virtualized file server. The file server manager 102 may access the identity of the software versions in metadata 136 and/or registration information 144. Based on the versions of the software, the API call may be formatted accordingly. Appropriate variations of API calls for use by different versions of virtualized file server software may be stored by the file server manager in storage accessible to the file server manager, such as with registration information 144 and/or metadata 136.

To route the API call to an appropriate virtualized file server, or to multiple virtualized file servers, the gateway 146 may identify a target virtualized file server in the API call. The API call may contain an identity of a target virtualized file server. In some examples, the identity may be used to route the API call (e.g., a URI or URL). In some examples, the gateway 146 may look up a URI or URL of a target virtualized file server based on other identification information (e.g., a name) included in the API call. For example, the metadata 136 and/or registration information 144 may include an association between file server names and URIs and/or URLs.

During operation, the file server manager may utilize information (e.g., file server metadata) from the registration to implement the management request. For example, access credentials provided during registration may be used to access one or more FSVMs and/or other components of the virtualized file server (e.g., hypervisors, containers, other virtual machines (VMs)) and implement the management request. In some examples, the management request may be provided to a particular FSVM. In some examples, the management request may be provided to an FSVM of the virtualized file server that is designated as a leader, and the leader FSVM may communicate the management request to an appropriate FSVM of the virtualized file server.

In some examples, file server managers described herein, such as file server manager 102 of FIG. 1, may be used to implement one or more cross-file server policies. A cross-file server policy may generally refer to a policy that accesses and/or utilizes more than one file server in implementing the policy. For example, one virtualized file server may be used (e.g., designated) as a destination file server and another virtualized file server may be used (e.g., designated) as a source file server. For example, the file server manager 102 may designate virtualized file server 106 as a source file server and virtualized file server 114 as a destination file server. The file server manager 102 may then utilize virtualized file server 106 to replicate, backup, provide redundancy for, or otherwise receive data from virtualized file server 106. For example, the file server manager 102 may implement a replication policy from virtualized file server 106 to virtualized file server 114. Without the presence of file server manager 102 in some examples, the virtualized file server 106 may have been used to implement a replication policy to virtualized file server 114 directly. However, utilizing file server manager 102 provides for central cross-server management and avoids a need for individual file servers to communicate with one another directly.

Examples of file server managers and virtualized file servers that may be used to implement systems described herein are further described in U.S. Published Application No. 2023/0056425, published Feb. 23, 2023, and entitled “File server managers and systems for managing virtualized file servers,” which publication is hereby incorporated by reference in its entirety for any purpose.

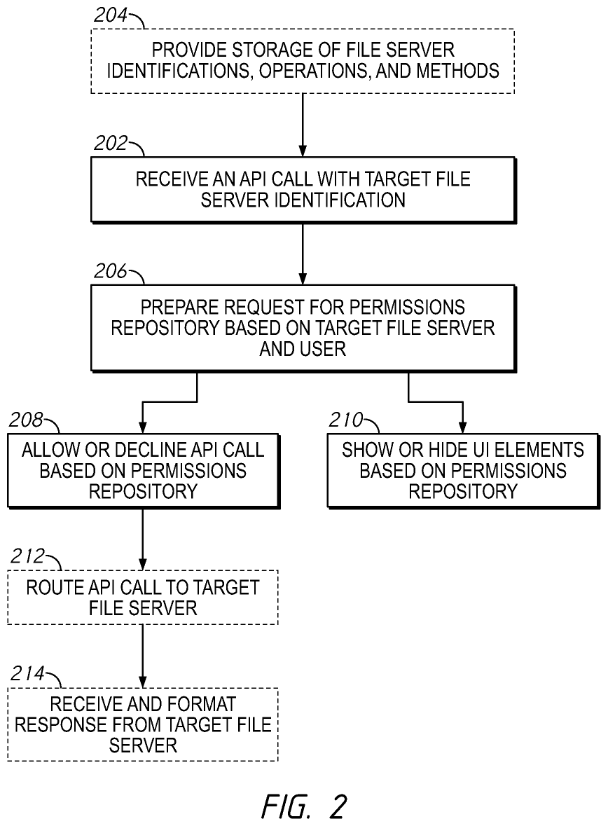

FIG. 2 is a schematic illustration of a process arranged in accordance with examples described herein. The process may include block 204 “provide storage of file server identifications, operations, and methods.” Block 202 may follow block 204. Block 202 recites “receive an API call with target file server identification.” Block 206 may follow block 202. Block 206 recites “prepare request for permissions repository based on target file server and user.” Block 208 and/or block 210 may follow block 206. Block 208 recites “allow or decline API call based on permissions repository.” Block 210 recites “show or hide UI elements based on permissions repository.” Block 212 may follow block 208. Block 212 recites “route API call to target file server.” Block 214 may follow block 212. Block 214 recites “receive and format response from target file server.”

The blocks, and arrangement of blocks, in FIG. 2 are exemplary only. Additional, fewer, and/or different blocks may be used in other examples. The blocks may occur in other orders in other examples. The process of FIG. 2 may be implemented, for example, using the system of FIG. 1. For example, the file server manager 102 of FIG. 1 may include one or more computer-readable media encoded with instructions which, when executed by the file server manager 102, perform the operations described in FIG. 2.

Block 204 recites “provide storage of file server identifications, operations, and methods.” Examples of systems described herein may store associations between file server identifications and the operations and methods (e.g., API methods) which may be supported by and/or expected for use at each file server. The associations may be stored, for example, by registration information 144 and/or metadata 136 of FIG. 1. The information be stored in other storage accessible to file server managers in other examples. File server managers described herein may in some examples collect and store these associations. For example, the file server manager 102 may read a configuration file which may be stored in registration information 144. The file server identifications may include a name, URL, and/or UID. The operations may include operations supported by the file server including, but not limited to, create share, scale in, scale out, and policy creation. The methods may include API calls supported by the file servers including, for example, GET, PUT, POST, DELETE, and/or PATCH. Other API calls may be supported.

Block 202, which may follow block 204, recites “receive an API call with target file server identification.” An API call may be received by file server managers described herein, such as by file server manager 102 of FIG. 1. The API call may be sent by a client (e.g., an application and/or user). The client may in some examples be external to the file server manager and managed virtualized file servers. The client may in some examples be hosted on the file server manager. The client may in some examples be hosted on one or more of the managed virtualized file servers, such as virtualized file server 106, virtualized file server 114, and/or virtualized file server 122 of FIG. 1 (e.g., in a container or user virtual machine on one or more of the managed virtualized file servers). The API call may include and/or imply a target file server. For example, the API call may include a name, URL and/or URI for a target file server. In some examples, a gateway of the file server manager, such as gateway 146 of FIG. 1, may receive the API call. In some examples, the file server manager may receive a variety of API calls. Some API calls may be related to the managed virtualized file servers, and others may be unrelated. The gateway 146 may identify, based on a comparison of the target file server identified in the API call with the stored file server identifications in block 204, that the API call pertains to a target virtualized file server managed by the file server manager. In some examples, the gateway 146 may access a stored conversion between different types of file server identifications. For example, the gateway 146 may receive an API including a target file server name and may access an association between the target file server name and the target file server URL and/or URI. The association may be stored, for example, in registration information 144. The API call may include additional information including a method and/or operation type. The API call may include additional information such as a payload to be used in conducting a requested operation.

Block 206, which may follow block 202, recites “prepare request for permissions repository based on target file server and user.” Block 206 may be performed by file server managers described herein, such as by file server manager 102 of FIG. 1. A gateway may perform block 206, such as gateway 146 of FIG. 1. The file server manager and/or gateway may determine that an API call is intended for a target file server. Accordingly, the file server manager may advantageously determine whether a particular user making the API call has appropriate permissions to perform the requested action. The file server manager, such as a gateway of the file server manager, may accordingly prepare a request for a permissions repository. For example, the gateway 146 of FIG. 1 may prepare a request for the API permissions repository 148. The request may include the target file server identification and a user identification. The user identification may be obtained by the file server manager, for example, by accessing information regarding a logged in user, such as may be stored in registration information 144. In some examples, a user identification may be included in and/or derived from the API call. In some examples, the request to the permissions repository may additionally or instead include information regarding operations and/or methods requested in the API call. The permissions repository, such as API permissions repository 148 of FIG. 1, may return a set of permissions for a user particular to a target file server and/or requested operation or method. For example, the API permissions repository 148 of FIG. 1 may return a set of API-level permissions held by the user for the target file server. The API-level permissions may include a set of operations and/or methods the user is authorized to call. In some examples, the API permissions repository may return a positive or negative response—e.g., allow or decline-based on the requested operation or method in the API call and the stored permissions.

Block 208, which may follow block 206, recites “allow or decline API call based on permissions repository.” In some examples, a file server manager, such as file server manager 102, may receive an allow or deny indication from the API permissions repository. In some examples, a file server manager may receive a set of API-level permissions held by a user and the file server manager itself may evaluate whether the API-level permissions include authorization to perform the requested operation or method in the received API call. If the file server manager determines that the user has authorization to perform the requested operation or method (e.g., receives an allow indication from the permissions repository), the API call may be allowed and the operation or method may be initiated, e.g., by the file server manager. If the file server manager determines that the user does not have authorization to perform the requested operation or method (e.g., receives a decline indication from the permissions repository), the API call may be declined. A user may receive an error message or other indication that the operation or method will not be performed.

When the API call is allowed, in some examples the requested operation or method may be intended for performance by the file server manager. For example, certain cross-file server policy setting operations and/or operations external to a virtualized file server may be intended for performance by the file server manager (e.g., upgrade, create share, set policies, set disaster recovery and/or replication policy). If the API call includes an operation to be performed by the file server manager and the API call is allowed in block 208, the file server manager may perform the operation.

Block 212 may follow block 208. Block 212 recites “route API call to target file server.” In some examples, the API call may be for an operation or method to be performed by a managed virtualized file server. Examples of operations that may be performed by a managed virtualized file server include enumeration of files or directories, and changing ownership of one or more vdisks. The file server manager may route the API call to the target file server. For example, the gateway 146 of FIG. 1 may route the API call to the appropriate target file server based on the URL and/or URI of the target file server. The URL and/or URI of the target file server may be stored in metadata 136 and/or registration information 144 and/or provided with the API call. When routing the API call to the target file server, the file server manager may format or otherwise adjust the API call in a manner appropriate for a version of software on the target file server. For example, the file server manager may access version information stored in metadata 136 and/or registration information 144. The API call may be formatted for the appropriate file server version. In some examples, the API call may be formatted for a particular virtualization environment of the target file server. Note that the API call may be routed to a target file server after permissions have been examined by the file server manager for the API call, e.g., in block 208 or before. In this manner file server managers described herein may facilitate both APIs hosted by the file server manager itself as well as route APIs to file servers where the APIs are hosted by the file servers.

Block 214 may follow block 212. Block 214 recites “receive and format response from target file server.” After an API call is routed to a target file server in block 212, the target file server may provide a response. For example, the target file server may indicate that an operation responsive to the API call is complete, or has terminated due to error, or provide a result of the operation. In some examples, the file server manager may format the response of the target file server for communication to the user having sent the API call or other user or system. For example, the response may be formatted from a particular format or syntax used by the target file server (e.g., by a version of software present on the target file server) to a format or syntax used by the requestor and/or another system which may access the response.

Block 210 may follow block 206. Block 210 recites “show or hide UI elements based on permissions repository.” Recall in block 206 a request was prepared and provided to the API permissions repository. Based on the permissions for the user, target file server, and/or requested operation or method, the UI presented to a user may be altered. For example, the gateway 146 of FIG. 1 may receive an indication from the API permissions repository 148 that a user has permissions for a subset of available operations on a target file server. In some examples only those available operations may be shown on the user interface 104. Other operations may be removed or hidden from the user interface 104 when viewed by that user.

Examples of systems described herein may implement role-based access permissions for API operations and methods. Further, examples of systems described herein may facilitate automatic assigning of dependent permissions when assigning particular other permissions and/or roles.

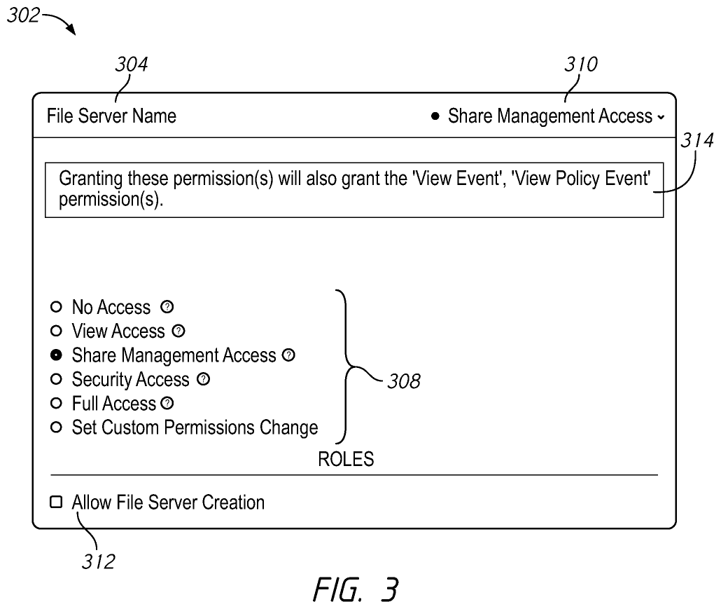

FIG. 3 is an example user interface arranged in accordance with examples described herein. The user interface 302 includes display of name 304, roles 308, selected role 310, additional permission 312, and a notification 314. The user interface 302 is exemplary only. The user interface 302 may be used to populate and/or update permissions repositories described herein, such as API permissions repository 148 of FIG. 1. Additional, fewer, and/or different user interface elements, roles, and/or permissions may be displayed in other examples.

The user interface 302 of FIG. 3 may be used to implement the user interface 104 in some examples. For example, the file server manager 102 of FIG. 1 may include computer-readable media encoded with instructions for generating the user interface display shown in FIG. 3 and making role-based permission assignments as described herein.

The user interface 302 of FIG. 3 may be used to assign role-based permissions to one or more users. While examples of role-based access (RBAC) are described herein, it is to be understood that in some examples or for some users, file servers, and/or shares, RBAC may not be used, but permissions may be assigned individually to users. An administrative or other super user may access the user interface 302, for example, by requesting permission updates from a file server manager.

The user interface 302 may display a name of a file server to which the permissions assignment will pertain, e.g., name 304. In some examples, the permissions assignment may pertain to multiple file servers. The user interface 302 may display multiple options for roles to assign to a user. For example, in FIG. 3 the roles no access role, view access role, share management access role, security access role, and full access role are shown. Each role may have a set of permissions associated with the role. The permissions may be certain operations and/or methods to be performed. For example, the share management access role may have associated permissions. The permissions may be based on a target file server and/or file share. For example, the share management access role may include permissions: create file server share, create file server share virus scan policy, create quota policy for a file server share, delete quota policy for a file server share, delete snapshot for a file server share, restore file server share, update file server share, update file server share virus scan policy, update quota policy for a file server share, view file server, view file server antivirus server, view file server name services, view file server share, view file server share virus scan policy, view file server user mapping, view quota policy for file server share, view snapshot for file server share. Other permissions may be included in other examples. The security access role may include a different set of permissions. For example, the security access role may include permissions for operations and methods to support antivirus and ransomware detection, monitoring, and recovery. For example, the security access role may be associated with permissions for: add file server dns entries, configure file server name services, create file server antivirus server, create file server virus scan policy, delete file server antivirus server, delete snapshot file server share, quarantine file server antivirus infected, remove file server antivirus infected files, remove file server dns entries, rescan file server antivirus infected files, reset file server antivirus infected files, unquarantine file server antivirus infected files, update file server antivirus server, update file server ransomware configuration, update file server virus scan policy, verify file server dns entries, view file server, view file server antivirus infected files, view file server antivirus server, view file server name services, view file server ransomware configuration, view file server share, view file server virus scan policy, view snapshot for file server share.

In the example of FIG. 3, the roles 308 may be selected via user interface 302 by selecting a radio button next to the selected role. Other mechanisms for role selection may additionally or instead be used, including a drop down menu, button se lection, and/or text input. In the example of FIG. 3, the selected role may also be displayed at selected role 310, and may be further selected or reviewed for information pertaining to the selected role.

User interfaces described herein may include an ability to allow additional specific permissions. For example, the user interface 302 includes an option for additional permission 312. The additional permission 312 in the example of FIG. 3 is to allow file server creation.

A role assigned to a particular user, such as the role assigned through user interface 302, may be stored in API permissions repository 148. In some examples, the permissions associated with the role may be stored in the API permissions repository 148. In some examples, permissions associated with a user may be stored in API permissions repository 148.

Examples of systems described herein may automatically provide dependent permissions to a user when a permission is requested for that user which would require the dependent permission. For example, the file server manager may receive an indication of a requested role and/or permission for a user. The file server manager may compare a selected role received through the user interface 104 with permissions that may be required to implement the selected role. If the user was not currently associated with those required permissions, the file server manager may provide an indication that additional permissions would be assigned to achieve the requested role. In the example of FIG. 3, the role share management access has been selected for a user. The file server manager provided notification 314. The notification 314 indicates that this selected role will also cause the user to receive permissions for view event and view policy event. Associations between roles, permissions, and dependent permissions may be stored in permissions repositories described herein, such as API permissions repository 148 of FIG. 1. The file server manager may access these associations in assigning dependent permissions when a role for a user is selected.

In some examples, a network permission may be required to implement a selected role for a user. For example, communication between the file server manager and managed file servers may occur over one or more networks. To accomplish a selected role for a user on a selected file server, a network permission for the user may be needed to communicate with the file server over the network. File server managers described herein may include computer-readable media encoded with executable instructions for identifying that a network permission is required. For example, the file server manager may access an association between the network used by the file server manager and a need to communicate over the network for a particular permission. Based on this association, the file server manager may prompt an administrator to provide the network permission. The notification 314 of FIG. 3 may accordingly, in some examples, be a prompt to provide network permissions for the user to achieve the selected role.

Examples of systems and methods described herein may include a file server manager in communication with one or more virtualized file servers. Examples of virtualized file servers which may be used to implement virtualized file servers are described in, for example, U.S. Published Patent Application 2017/0235760, entitled “Virtualized file server,” published Aug. 17, 2017 on U.S. application Ser. No. 15/422,420, filed Feb. 1, 2017, both of which documents are hereby incorporated by reference in their entirety for any purpose.

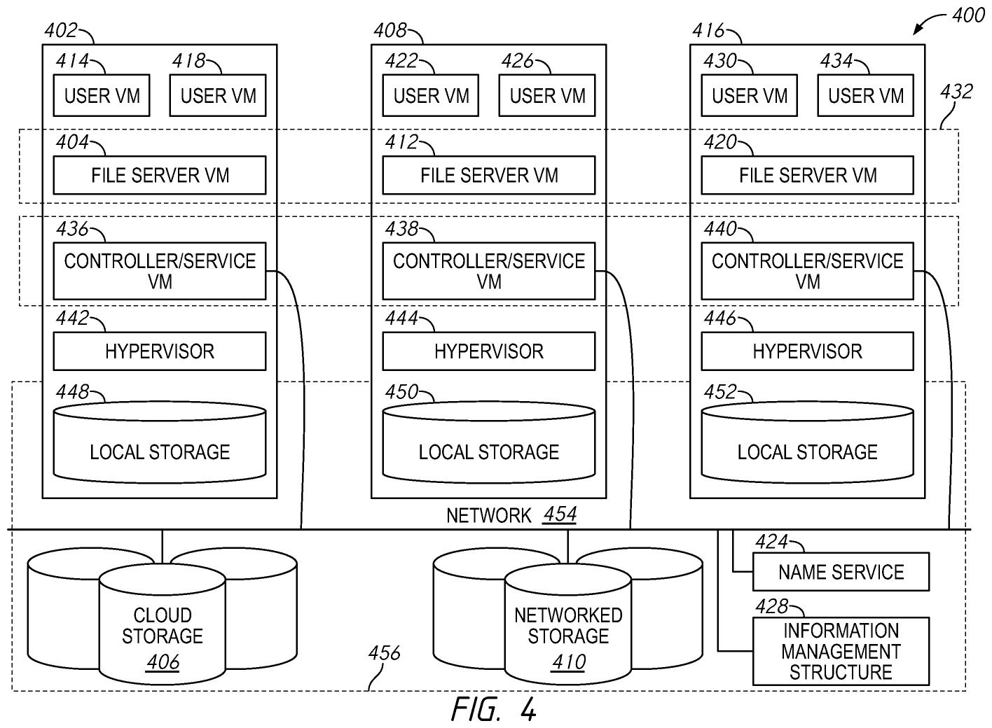

FIG. 4 is a schematic illustration of a clustered virtualization environment 400 implementing a VFS 432 according to particular embodiments. In particular embodiments, the VFS 432 provides file services to user VMs 414, 418, 422, 426, 430, and 434. Each user VM may be a client as used herein and/or a user. The file services may include storing and retrieving data persistently, reliably, and efficiently. The user virtual machines may execute user processes, such as office applications or the like, on host machines 402, 408, and 416. The stored data may be represented as a set of storage items, such as files organized in a hierarchical structure of folders (also known as directories), which can contain files and other folders, and shares, which can also contain files and folders.

The clustered virtualization environment 400 and/or VFS 432 may be used to implement one or more virtualization platforms and/or virtualized file servers described herein, such as the virtualized file server 106, virtualized file server 114, and/or virtualized file server 122 of FIG. 1 and/or any other virtualized file server described herein.

The architectures of FIG. 4 can be implemented for a distributed platform that contains multiple host machines 402, 416, and 408 that manage multiple tiers of storage. The multiple tiers of storage may include storage that is accessible through network 454, such as, by way of example and not limitation, cloud storage 406 (e.g., which may be accessible through the Internet), network-attached storage (NAS) 410 (e.g., which may be accessible through a LAN), or a storage area network (SAN). Examples described herein also permit local storage 448, 450, and 452 that is incorporated into or directly attached to the host machine and/or appliance to be managed as part of storage pool 456. Examples of such local storage include Solid State Drives (SSDs), Hard Disk Drives (HDDs or “spindle drives”), optical disk drives, external drives (e.g., a storage device connected to a host machine via a native drive interface or a serial attached SCSI interface), or any other direct-attached storage. These storage devices, both direct-attached and network-accessible, collectively form storage pool 456. Virtual disks (or “vDisks”) may be structured from the physical storage devices in storage pool 456. As used herein, the term vDisk refers to the storage abstraction that is exposed by a component of the virtualization platform, such as a Controller/Service VM (CVM) (e.g., CVM 436) and/or a hypervisor or other storage controller to be used by a user VM (e.g., user VM 414). In particular embodiments, the vDisk may be exposed via iSCSI (internet small computer system interface) or NFS (network filesystem) and is mounted as a virtual disk on the user VM. In particular embodiments, vDisks may be organized into one or more volume groups (VGs).

Each host machine 402, 416, 408 may run virtualization software, such as VMWARE ESX (I), MICROSOFT HYPER-V, or REDHAT KVM. The virtualization software includes hypervisors 442, 444, and 446 to create, manage, and destroy user VMs, as well as managing the interactions between the underlying hardware and user VMs. User VMs may run one or more applications that may operate as “clients” with respect to other elements within clustered virtualization environment 400. A hypervisor may connect to network 454. In particular embodiments, a host machine 402, 408, or 416 may be a physical hardware computing device; in particular embodiments, a host machine 402, 408, or 416 may be a virtual machine.

CVMs 436, 438, and 440 are used to manage storage and input/output (“I/O”) activities according to particular embodiments. These special VMs act as the storage controller in the currently described architecture. While CVMs are described, in other examples, a different storage controller may be used. Multiple such storage controllers may coordinate within a cluster to form a unified storage controller system. CVMs may run as virtual machines on the various host machines, and work together to form a distributed system that manages all the storage resources, including local storage, NAS 410, and cloud storage 406. The CVMs may connect to network 454 directly, or via a hypervisor. Since the CVMs 436, 438, and 440 run independent of hypervisors 442, 444, 446, this means that the current approach can be used and implemented within any virtual machine architecture, since the CVMs of particular embodiments can be used in conjunction with any hypervisor from any virtualization vendor. In some examples, CVMs may not be used and one or more hypervisors (e.g., hypervisors 442, 444, and/or 446) may perform the functions described with respect to the CVMs. In some examples, one or more CVMs may not be present, and the hypervisor and/or other component hosted on the computing nodes may provide the functions attributed to the CVM herein.

A host machine may be designated as a leader node within a cluster of host machines. For example, host machine 408 may be a leader node. A leader node may have a software component designated to perform operations of the leader. For example, CVM 438 on host machine 408 may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node and/or in communication with the leader node or virtual machines or containers on the leader node. For example, file server managers described herein may be in communication with the leader node in some examples.

Each CVM 436, 438, and 440 exports one or more block devices or NFS server targets that appear as disks to user VMs 414, 418, 422, 426, 430, and 434. These disks are virtual, since they are implemented by the software running inside CVMs 436, 438, and 440. Thus, to user VMs, CVMs appear to be exporting a clustered storage appliance that contains some disks. All user data (including the operating system) in the user VMs may reside on these virtual disks.

Significant performance advantages can be gained by allowing the virtualization system to access and utilize local storage 448, 450, and 452 as disclosed herein. This is because I/O performance is typically much faster when performing access to local storage as compared to performing access to NAS 410 across a network 454. This faster performance for locally attached storage can be increased even further by using certain types of optimized local storage devices, such as SSDs. Further details regarding methods and mechanisms for implementing the virtualization environment illustrated in FIG. 4 are described in U.S. Pat. No. 8,601,473, which is hereby incorporated by reference in its entirety for any purpose.

As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 456. Additionally or alternatively, CVMs 436, 438, 440 may present an emulated storage controller either to the hypervisor or to user VMs to facilitate I/O operations. CVMs 436, 438, and 440 may be connected to storage within storage pool 456. CVM 436 may have the ability to perform I/O operations using local storage 448 within the same host machine 402, by connecting via network 454 to cloud storage 406 or NAS 410, or by connecting via network 454 to local storage 450 or 452 within another host machine 408 or 416 (e.g., via connecting to another CVM 438 or 440). In particular embodiments, any suitable computing system may be used to implement a host machine.

In particular embodiments, the VFS 432 may include a set of FSVMs 404, 412, and 420 that execute on host machines 402, 408, and 416 and process storage item access operations requested by user VMs executing on the host machines 402, 408, and 416. While described as VMs, it is to be understood that the FSVMs may be implemented using containers in some examples, and/or that containers may be used instead of FSVMs. The containers used instead of an FSVM may implement one or more protocol stacks for file systems (e.g., NFS and/or SMB). The FSVMs 404, 412, and 420 may communicate with storage controllers provided by CVMs 436, 438, 440 and/or hypervisors executing on the host machines 402, 408, 416 to store and retrieve files, folders, SMB shares, or other storage items on local storage 448, 450, 452 associated with, e.g., local to, the host machines 402, 408, 416. The FSVMs 404, 412, 420 may store and retrieve block-level data on the host machines 402, 408, 416, e.g., on the local storage 448, 450, 452 of the host machines 402, 408, 416. The block-level data may include block-level representations of the storage items (e.g., files, shares). The network protocol used for communication between user VMs, FSVMs, and CVMs via the network 454 may be Internet Small Computer Systems Interface (ISCSI), SMB, NFS, pNFS (Parallel NFS), or another appropriate protocol.

For the purposes of VFS 432, host machine 416 may be designated as a leader node within a cluster of host machines. In this case, FSVM 420 on host machine 416 may be designated to perform such operations. A leader may be responsible for monitoring or handling requests from FSVMs on other host machines throughout the virtualized environment. If FSVM 420 fails, a new leader may be designated for VFS 432.

In particular embodiments, the user VMs may send data to the VFS 432 (e.g., to the FSVMs) using write requests, and may receive data from it using read requests. The read and write requests, and their associated parameters, data, and results, may be sent between a user VM and one or more FSVMs located on the same host machine as the user VM or on different host machines from the user VM. The read and write requests may be sent between host machines 402, 408, 416 via network 454, e.g., using a network communication protocol such as iSCSI, CIFS, SMB, TCP, IP, or the like. When a read or write request is sent between two VMs located on the same one of the host machines 402, 408, 416 (e.g., between the user VM 414 and the FSVM 404 located on the host machine 402), the request may be sent using local communication within the host machine 402 instead of via the network 454. As described above, such local communication may be substantially faster than communication via the network 454. The local communication may be performed by, e.g., writing to and reading from shared memory accessible by the user VM 414 and the FSVM 404, sending and receiving data via a local “loopback” network interface, local stream communication, or the like.

In particular embodiments, the storage items stored by the VFS 432, such as files and folders, may be distributed amongst multiple FSVMs 404, 412, 420. In particular embodiments, when storage access requests are received from the user VMs, the VFS 432 identifies FSVMs 404, 412, 420 at which requested storage items, e.g., folders, files, or portions thereof, are stored, and directs the user VMs to the locations of the storage items. The FSVMs 404, 412, 420 may maintain a storage map, such as a sharding map, that maps names or identifiers of storage items to their corresponding locations. The storage map may be a distributed data structure of which copies are maintained at each FSVM 404, 412, 420 and accessed using distributed locks or other storage item access operations. Alternatively, the storage map may be maintained by an FSVM at a leader node such as the FSVM 420, and the other FSVMs 404 and 412 may send requests to query and update the storage map to the leader FSVM 420. Other implementations of the storage map are possible using appropriate techniques to provide asynchronous data access to a shared resource by multiple readers and writers. The storage map may map names or identifiers of storage items in the form of text strings or numeric identifiers, such as folder names, files names, and/or identifiers of portions of folders or files (e.g., numeric start offset positions and counts in bytes or other units) to locations of the files, folders, or portions thereof. Locations may be represented as names of FSVMs, e.g., “FSVM-1”, as network addresses of host machines on which FSVMs are located (e.g., “ip-addr1” or 128.1.1.10), or as other types of location identifiers.

When a user application executing in a user VM 414 on one of the host machines 402 initiates a storage access operation, such as reading or writing data, the user VM 414 may send the storage access operation in a request to one of the FSVMs 404, 412, 420 on one of the host machines 402, 408, 416. A FSVM 412 executing on a host machine 408 that receives a storage access request may use the storage map to determine whether the requested file or folder is located on the FSVM 412. If the requested file or folder is located on the FSVM 412, the FSVM 412 executes the requested storage access operation. Otherwise, the FSVM 412 responds to the request with an indication that the data is not on the FSVM 412, and may redirect the requesting user VM 414 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 404 by sending a file service operation that creates the file or folder to a CVM 436 and/or hypervisor 442 associated with (e.g., located on the same host machine as) the FSVM 404. The CVM 436 subsequently processes file service commands for that file for the FSVM 404 and sends corresponding storage access operations to storage devices associated with the file. The CVM 436 may associate local storage 448 with the file if there is sufficient free space on local storage 448. Alternatively, the CVM 436 may associate a storage device located on another host machine, e.g., in local storage 450, with the file under certain conditions, e.g., if there is insufficient free space on the local storage 448, or if storage access operations between the CVM 436 and the file are expected to be infrequent. Files and folders, or portions thereof, may also be stored on other storage devices, such as the NAS 410 or the cloud storage 406 of the storage pool 456.

In particular embodiments, a name service 424, such as that specified by the Domain Name System (DNS) Internet protocol, may communicate with the host machines 402, 408, 416 via the network 454 and may store a database of domain name (e.g., host name) to IP address mappings. The domain names may correspond to FSVMs, e.g., fsvm1.domain.com or ip-addr1.domain.com for an FSVM named FSVM-1. The name service 424 may be queried by the user VMs to determine the IP address of a particular host machine 402, 408, 416 given a name of the host machine, e.g., to determine the IP address of the host name ip-addr1 for the host machine 402. The name service 424 may be located on a separate server computer system or on one or more of the host machines 402, 408, 416. The names and IP addresses of the host machines of the VFS 432, e.g., the host machines 402, 408, 416, may be stored in the name service 424 so that the user VMs may determine the IP address of each of the host machines 402, 408, 416, or FSVMs 404, 412, 420. The name of each VFS instance, e.g., each file system such as FS1, FS2, or the like, may be stored in the name service 424 in association with a set of one or more names that contains the name(s) of the host machines 402, 408, 416 or FSVMs 404, 412, 420 of the VFS instance VFS 432. The FSVMs 404, 412, 420 may be associated with the host names ip-addr1, ip-addr2, and ip-addr3, respectively. For example, the file server instance name FS1.domain.com may be associated with the host names ip-addr1, ip-addr2, and ip-addr3 in the name service 424, so that a query of the name service 424 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 424 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 424 for the address of the VFS instance for storage items for which the user VMs do not have a record or cache entry, as described below.

In particular embodiments, each FSVM may have two IP addresses: an external IP address and an internal IP address. The external IP addresses may be used by SMB/CIFS clients, such as user VMs, to connect to the FSVMs. The external IP addresses may be stored in the name service 424. The IP addresses ip-addr1, ip-addr2, and ip-addr3 described above are examples of external IP addresses. The internal IP addresses may be used for iSCSI communication to CVMs and/or hypervisors, e.g., between the FSVMs 404, 412, 420 and the CVMs 436, 438, 440 and/or hypervisors 442, 444, and/or 446. Other internal communications may be sent via the internal IP addresses as well, e.g., file server configuration information may be sent from the CVMs to the FSVMs using the internal IP addresses, and the CVMs may get file server statistics from the FSVMs via internal communication as needed.

Since the VFS 432 is provided by a distributed set of FSVMs 404, 412, 420, the user VMs that access particular requested storage items, such as files or folders, do not necessarily know the locations of the requested storage items when the request is received. A distributed file system protocol, e.g., MICROSOFT DFS or the like, is therefore used, in which a user VM 414 may request the addresses of FSVMs 404, 412, 420 from a name service 424 (e.g., DNS). The name service 424 may send one or more network addresses of FSVMs 404, 412, 420 to the user VM 414, in an order that changes for each subsequent request. These network addresses are not necessarily the addresses of the FSVM 412 on which the storage item requested by the user VM 414 is located, since the name service 424 does not necessarily have information about the mapping between storage items and FSVMs 404, 412, 420. Next, the user VM 414 may send an access request to one of the network addresses provided by the name service, e.g., the address of FSVM 412. The FSVM 412 may receive the access request and determine whether the storage item identified by the request is located on the FSVM 412. If so, the FSVM 412 may process the request and send the results to the requesting user VM 414. However, if the identified storage item is located on a different FSVM 420, then the FSVM 412 may redirect the user VM 414 to the FSVM 420 on which the requested storage item is located by sending a “redirect” response referencing FSVM 420 to the user VM 414. The user VM 414 may then send the access request to FSVM 420, which may perform the requested operation for the identified storage item.

A particular virtualized file server, such as VFS 432, including the items it stores, e.g., files and folders, may be referred to herein as a VFS “instance” and/or a file system and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients such as user VMs by name, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1\File-1”, in storage access operations. If the storage items are stored on a share (e.g., a shared drive), then the share name may be used to access the storage items, e.g., via the path name “\\Share-1\Folder-1\File-1” to access File-1 in folder Folder-1 on a share named Share-1.

In particular embodiments, although the VFS instance may store different folders, files, or portions thereof at different locations, e.g., on different FSVMs, the use of different FSVMs or other elements of storage pool 456 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, are similarly location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 432 determines the location, e.g., FSVM, at which to store a storage item when the storage item is created. For example, a FSVM 404 may attempt to create a file or folder using a CVM 436 on the same host machine 402 as the user VM 418 that requested creation of the file, so that the CVM 436 that controls access operations to the file folder is co-located with the user VM 418. In this way, since the user VM 418 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 432 may also attempt to store the file on a storage device that is local to the CVM being used to create the file, such as local storage, so that storage access operations between the CVM and local storage may use local or short-distance communication.

In particular embodiments, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In particular embodiments, if a virtual machine, such as a user VM 414, CVM 436, or FSVM 404, moves from a host machine 402 to a destination host machine 408, e.g., because of resource availability changes, and data items such as files or folders associated with the VM 414 are not locally accessible on the destination host machine 408, then data migration may be performed for the data items associated with the moved VM 414 to migrate them to the new host machine 408, so that they are local to the moved VM 414 on the new host machine 408. FSVMs may detect removal and addition of CVMs (as may occur, for example, when a CVM fails or is shut down) via the iSCSI protocol or other technique, such as heartbeat messages. As another example, a FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 432 may change the location of the file by, for example, copying the file from its existing location(s), such as local storage 448 of host machine 402, to its new location(s), such as local storage 450 of host machine 408 (and to or from other host machines, such as local storage 452 of host machine 416 if appropriate), and deleting the file from its existing location(s). Write operations on the file may be blocked or queued while the file is being copied, so that the copy is consistent. The VFS 432 may also redirect storage access requests for the file from an FSVM at the file's existing location to a FSVM at the file's new location.

In particular embodiments, VFS 432 includes at least three File Server Virtual Machines (FSVMs) 404, 412, 420 located on three respective host machines 402, 408, 416. To provide high-availability, there may be in some examples a maximum of one FSVM per host machine in a cluster. If two FSVMs are detected on a single host machine, then one of the FSVMs may be moved to another host machine automatically, or the user (e.g., system administrator and/or file server manager) may be notified to move the FSVM to another host machine. The user and/or file server manager may move a FSVM to another host machine using an administrative interface that provides commands for starting, stopping, and moving FSVMs between host machines.

In particular embodiments, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which would be more disruptive and more difficult to recover from than loss of one-third of the FSVMs for the VFS instance.

In particular embodiments, users, such as system administrators or other users of the user VMs, may expand the cluster of FSVMs by adding additional FSVMs. Each FSVM may be associated with at least one network address, such as an IP address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as name service.

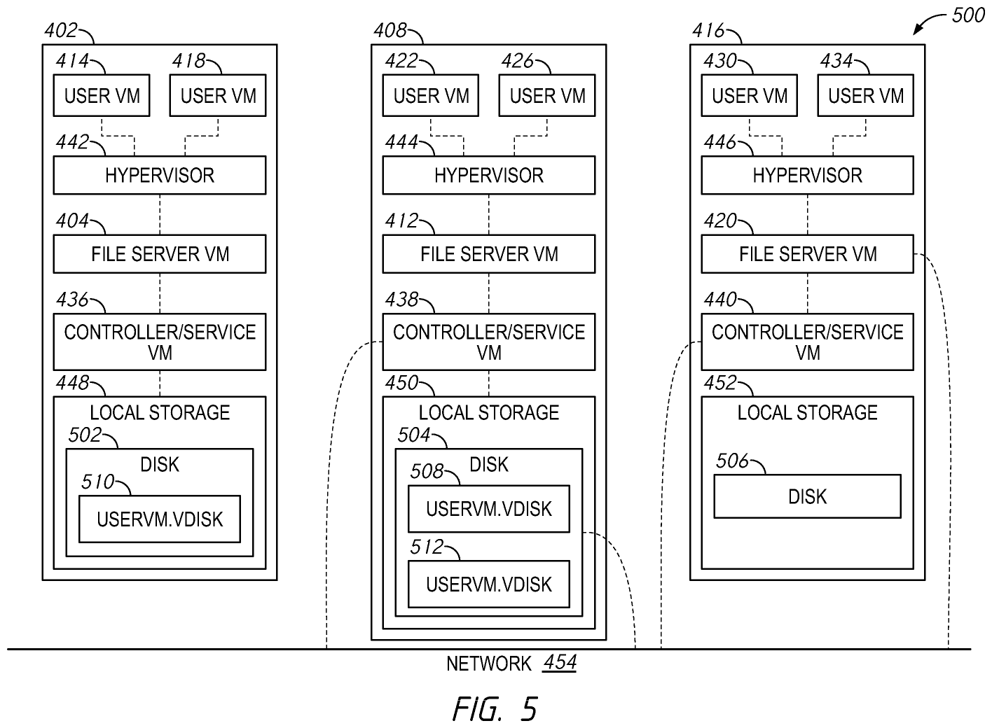

FIG. 5 illustrates data flow within a clustered virtualization environment 500 implementing a VFS instance (e.g., VFS 432) in which stored items such as files and folders used by user VMs are stored locally on the same host machines as the user VMs according to particular embodiments. As described above, one or more user VMs and a Controller/Service VM and/or hypervisor may run on each host machine. As a user VM processes I/O commands (e.g., a read or write operation), the I/O commands may be sent to the hypervisor on the same server or host machine as the user VM. For example, the hypervisor may present to the user VMs a VFS instance, receive an I/O command, and facilitate the performance of the I/O command by passing the command to a FSVM that performs the operation specified by the command. The VFS may facilitate I/O operations between a user VM and a virtualized file system. The virtualized file system may appear to the user VM as a namespace of mappable shared drives or mountable network file systems of files and directories. The namespace of the virtualized file system may be implemented using storage devices in the local storage, such as disks, onto which the shared drives or network file systems, files, and folders, or portions thereof, may be distributed as determined by the FSVMs. The VFS may thus provide features disclosed herein, such as efficient use of the disks, high availability, scalability, and others. The implementation of these features may be transparent to the user VMs. The FSVMs may present the storage capacity of the disks of the host machines as an efficient, highly-available, and scalable namespace in which the user VMs may create and access shares, files, folders, and the like.

As an example, a network share may be presented to a user VM as one or more discrete virtual disks, but each virtual disk may correspond to any part of one or more virtual or physical disks within a storage pool. Additionally or alternatively, the FSVMs may present a VFS either to the hypervisor or to user VMs of a host machine to facilitate I/O operations. The FSVMs may access the local storage via Controller/Service VMs, other storage controllers, hypervisors, or other components of the host machine. As described herein, a CVM 436 may have the ability to perform I/O operations using local storage 448 within the same host machine 402 by connecting via the network 454 to cloud storage or NAS, or by connecting via the network 454 to local storage 450, 452 within another host machine 408, 416 (e.g., by connecting to another CVM 438, 440).

In particular embodiments, each user VM may access one or more virtual disk images stored on one or more disks of the local storage, the cloud storage, and/or the NAS. The virtual disk images may contain data used by the user VMs, such as operating system images, application software, and user data, e.g., user home folders and user profile folders. For example, FIG. 5 illustrates three virtual machine images 510, 508, 512. The virtual machine image 510 may be a file named UserVM.vmdisk (or the like) stored on disk 502 of local storage 448 of host machine 402. The virtual machine image 510 may store the contents of the user VM 414's hard drive. The disk 502 on which the virtual machine image 510 is provided is “local to” the user VM 414 on host machine 402 because the disk 502 is in local storage 448 of the host machine 402 on which the user VM 414 is located. Thus, the user VM 414 may use local (intra-host machine) communication to access the virtual machine image 510 more efficiently, e.g., with less latency and higher throughput, than would be the case if the virtual machine image 510 were stored on disk 504 of local storage 450 of a different host machine 408, because inter-host machine communication across the network 454 would be used in the latter case. Similarly, a virtual machine image 508, which may be a file named UserVM.vmdisk (or the like), is stored on disk 504 of local storage 450 of host machine 408, and the image 508 is local to the user VM 422 located on host machine 408. Thus, the user VM 422 may access the virtual machine image 508 more efficiently than the virtual machine 418 on host machine 402, for example. In another example, the CVM 440 may be located on the same host machine 416 as the user VM 430 that accesses a virtual machine image 512 (UserVM.vmdisk) of the user VM 430, with the virtual machine image 512 being stored on a different host machine 408 than the user VM 430 and the CVM 440. In this example, communication between the user VM 430 and the CVM 440 may still be local, e.g., more efficient than communication between the user VM 430 and a CVM 438 on a different host machine 408, but communication between the CVM 440 and the disk 504 on which the virtual machine image 512 is stored is via the network 454, as shown by the dashed lines between CVM 440 and the network 454 and between the network 454 and local storage 450. The communication between CVM 440 and the disk 504 is not local, and thus may be less efficient than local communication such as may occur between the CVM 440 and a disk 506 in local storage 452 of host machine 416. Further, a user VM 430 on host machine 416 may access data such as the virtual machine image 512 stored on a remote (e.g., non-local) disk 504 via network communication with a CVM 438 located on the remote host machine 408. This case may occur if CVM 440 is not present on host machine 416, e.g., because CVM 440 has failed, or if the FSVM 420 has been configured to communicate with local storage 450 on host machine 408 via the CVM 438 on host machine 408, e.g., to reduce computational load on host machine 416.

In particular embodiments, since local communication is expected to be more efficient than remote communication, the FSVMs may store storage items, such as files or folders, e.g., the virtual disk images, as block-level data on local storage of the host machine on which the user VM that is expected to access the files is located. A user VM may be expected to access particular storage items if, for example, the storage items are associated with the user VM, such as by configuration information. For example, the virtual disk image 510 may be associated with the user VM 414 by configuration information of the user VM 414. Storage items may also be associated with a user VM via the identity of a user of the user VM. For example, files and folders owned by the same user ID as the user who is logged into the user VM 414 may be associated with the user VM 414. If the storage items expected to be accessed by a user VM 414 are not stored on the same host machine 402 as the user VM 414, e.g., because of insufficient available storage capacity in local storage 448 of the host machine 402, or because the storage items are expected to be accessed to a greater degree (e.g., more frequently or by more users) by a user VM 422 on a different host machine 408, then the user VM 414 may still communicate with a local CVM 436 to access the storage items located on the remote host machine 408, and the local CVM 436 may communicate with local storage 450 on the remote host machine 408 to access the storage items located on the remote host machine 408. If the user VM 414 on a host machine 402 does not or cannot use a local CVM 436 to access the storage items located on the remote host machine 408, e.g., because the local CVM 436 has crashed or the user VM 414 has been configured to use a remote CVM 438, then communication between the user VM 414 and local storage 450 on which the storage items are stored may be via a remote CVM 438 using the network 454, and the remote CVM 438 may access local storage 450 using local communication on host machine 408. As another example, a user VM 414 on a host machine 402 may access storage items located on a disk 506 of local storage 452 on another host machine 416 via a CVM 438 on an intermediary host machine 408 using network communication between the host machines 402 and 408 and between the host machines 408 and 416.

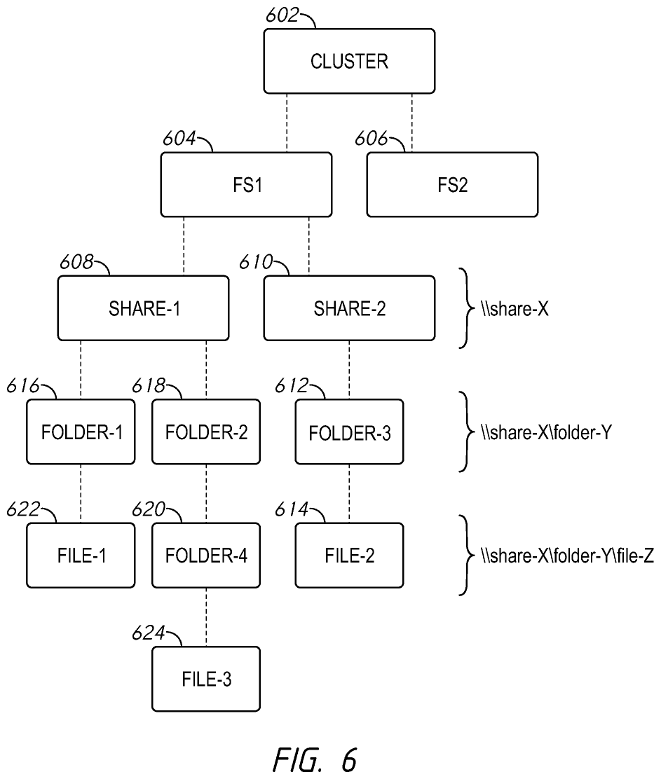

FIG. 6 illustrates an example hierarchical structure of a VFS instance (e.g., a file system) in a cluster (such as a virtualized file server) according to particular embodiments. A Cluster 602 contains two VFS instances, FS1 604 and FS2 606. For example, the 602 may be used to implement and/or may be implemented by a virtualized file server described herein, such as virtualized file server 122, virtualized file server 114, and/or virtualized file server 106 of FIG. 1. Each VFS instance as shown in FIG. 6 may be identified by a name such as “Winstance”, e.g., “\\FS1” for WINDOWS file systems, or a name such as “instance”, e.g., “FS1” for UNIX-type file systems. The VFS instance FS1 604 contains shares, including Share-1 608 and Share-2 610. Shares may have names such as “Users” for a share that stores user home directories, or the like. Each share may have a path name such as WFS1\Share-1 or WFS1\Users. As an example and not by way of limitation, a share may correspond to a disk partition or a pool of file system blocks on WINDOWS and UNIX-type file systems. As another example and not by way of limitation, a share may correspond to a folder or directory on a VFS instance. Shares may appear in the file system instance as folders or directories to users of user VMs. Share-1 608 includes two folders, Folder-1 616 and Folder-2 618, and may also include one or more files (e.g., files not in folders). Each folder Folder-1 616, Folder-2 618 may include one or more files 622, 624. Share-2 610 includes a folder Folder-3 612, which includes a file File-2 614. Each folder has a folder name such as “Folder-1”, “Users”, or “Sam” and a path name such as “\\FS1\Share-1\Folder-1” (WINDOWS) or “share-1:/fs1/Users/Sam” (UNIX). Similarly, each file has a file name such as “File-1” or “Forecast.xls” and a path name such as “\\FS1\Share-1\Folder-1\File-1” or “share-1:/fs1/Users/Sam/Forecast.xls”.

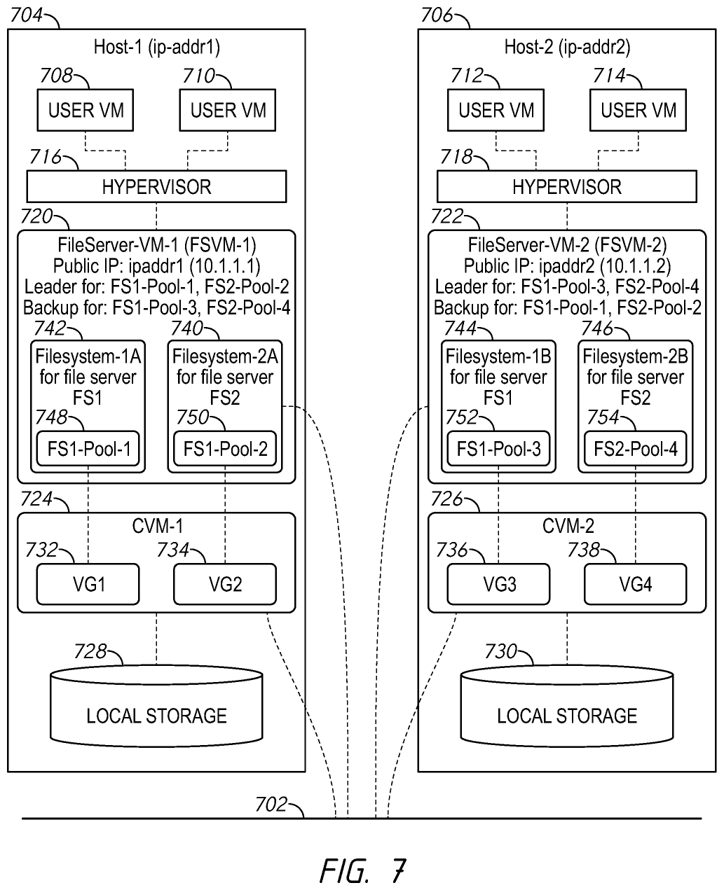

FIG. 7 illustrates two example host machines 704 and 706, each providing file storage services for portions of two VFS instances FS1 and FS2 according to particular embodiments. The first host machine, Host-1 704, includes two user VMs 708, 710, a hypervisor 716, a FSVM named FileServer-VM-1 (abbreviated FSVM-1) 720, a Controller/Service VM named CVM-1 724, and local storage 728. Host-1's 720 has an IP network address of 10.1.1.1, which is an address of a network interface on Host-1 704. Host-1 704 has a hostname ip-addr1, which may correspond to Host-1 704's IP address 10.1.1.1. The second host machine, Host-2 706, includes two user VMs 712, 714, a Hypervisor 718, a File Server VM named FileServer-VM-2 (abbreviated FSVM-2) 722, a Controller/Service VM named CVM-2 726, and local storage 730. Host-2 706's FileServer-VM-2 722 has an IP network address of 10.1.1.2, which is an address of a network interface on Host-2 706.

In particular embodiments, file systems FileSystem-1A 742 and FileSystem-2A 740 implement the structure of files and folders for portions of the FS1 and FS2 file server instances, respectively, that are located on (e.g., served by) FileServer-VM-1 720 on Host-1 704. Other file systems on other host machines may implement other portions of the FS1 and FS2 file server instances. The file systems 742 and 740 may implement the structure of at least a portion of a file server instance by translating file system operations, such as opening a file, writing data to or reading data from the file, deleting a file, and so on, to disk I/O operations such as seeking to a portion of the disk, reading or writing an index of file information, writing data to or reading data from blocks of the disk, allocating or de-allocating the blocks, and so on. The file systems 742, 740 may thus store their file system data, including the structure of the folder and file hierarchy, the names of the storage items (e.g., folders and files), and the contents of the storage items on one or more storage devices, such as local storage 728. The particular storage device or devices on which the file system data for each file system are stored may be specified by an associated file system pool (e.g., FS1-Pool-1 748 and FS2-Pool-2 750). For example, the storage device(s) on which data for FileSystem-1A 742 and FileSystem-2A 740 are stored may be specified by respective file system pools FS1-Pool-1 748 and FS2-Pool-2 750. The storage devices for the pool may be selected from volume groups provided by CVM-1 724, such as volume group VG1 732 and volume group VG2 734. Each volume group VG1 732, VG2 734 may include a group of one or more available storage devices that are present in local storage 728 associated with (e.g., by iSCSI communication) the CVM-1 724. The CVM-1 724 may be associated with a local storage 728 on the same host machine 704 as the CVM-1 724, or with a local storage 730 on a different host machine 706. The CVM-1 724 may also be associated with other types of storage, such as cloud storage, networked storage or the like. Although the examples described herein include particular host machines, virtual machines, file servers, file server instances, file server pools, CVMs, VGs, and associations there between, any number of host machines, virtual machines, file servers, file server instances, file server pools, CVMs, VGs, and any associations there between are possible and contemplated.

In particular embodiments, the file system pool FS1-Pool-1 748 may associate any storage device in one of the volume groups VG1 732, VG2 734 of storage devices that are available in local storage 728 with the file system FileSystem-1A 742. For example, the file system pool FS1-Pool-1 748 may specify that a disk device named hd1 in the volume group VG1 732 of local storage 728 is a storage device for FileSystem-1A 742 for file server FS1 on FSVM-1 720. A file system pool FS2-Pool-2 750 may specify a storage device FileSystem-2A 740 for file server FS2 on FSVM-1 720. The storage device for FileSystem-2A 740 may be, e.g., the disk device hd1, or a different device in one of the volume groups VG1 732, VG2 734, such as a disk device named hd2 in volume group VG2 734. Each of the file systems FileSystem-1A 742, FileSystem-2A 740 may be, e.g., an instance of the NTFS file system used by the WINDOWS operating system, of the UFS Unix file system, or the like. The term “file system” may also be used herein to refer to an instance of a type of file system, e.g., a particular structure of folders and files with particular names and content.

In one example, referring to FIG. 6 and FIG. 7, an FS1 hierarchy rooted at File Server FS1 604 may be located on FileServer-VM-1 720 and stored in file system instance FileSystem-1A 742. That is, the file system instance FileSystem-1A 742 may store the names of the shares and storage items (such as folders and files), as well as the contents of the storage items, shown in the hierarchy at and below File Server FS1 604. A portion of the FS1 hierarchy shown in FIG. 6, such as the portion rooted at Folder-2 618, may be located on FileServer-VM-2 722 on Host-2 706 instead of FileServer-VM-1 720, in which case the file system instance FileSystem-1B 744 may store the portion of the FS1 hierarchy rooted at Folder-2 618, including Folder-3 612, Folder-4 620 and File-3 624. Similarly, an FS2 hierarchy rooted at File Server FS2 606 in FIG. 6 may be located on FileServer-VM-1 720 and stored in file system instance FileSystem-2A 740. The FS2 hierarchy may be split into multiple portions (not shown), such that one portion is located on FileServer-VM-1 720 on Host-1 704, and another portion is located on FileServer-VM-2 722 on Host-2 706 and stored in file system instance FileSystem-2B 746.

In particular embodiments, FileServer-VM-1 (abbreviated FSVM-1) 720 on Host-1 704 is a leader for a portion of file server instance FS1 and a portion of FS2, and is a backup for another portion of FS1 and another portion of FS2. The portion of FS1 for which FileServer-VM-1 720 is a leader corresponds to a storage pool labeled FS1-Pool-1 748. FileServer-VM-1 is also a leader for FS2-Pool-2 750, and is a backup (e.g., is prepared to become a leader upon request, such as in response to a failure of another FSVM) for FS1-Pool-3 752 and FS2-Pool-4 754 on Host-2 706. In particular embodiments, FileServer-VM-2 (abbreviated FSVM-2) 722 is a leader for a portion of file server instance FS1 and a portion of FS2, and is a backup for another portion of FS1 and another portion of FS2. The portion of FS1 for which FSVM-2 722 is a leader corresponds to a storage pool labeled FS1-Pool-3 752. FSVM-2 722 is also a leader for FS2-Pool-4 754, and is a backup for FS1-Pool-1 748 and FS2-Pool-2 750 on Host-1 704.

In particular embodiments, the file server instances FS1, FS2 provided by the FSVMs 720 and 722 may be accessed by user VMs 708, 710, 712 and 714 via a network file system protocol such as SMB, CIFS, NFS, or the like. Each FSVM 720 and 722 may provide what appears to client applications on user VMs 708, 710, 712 and 714 to be a single file system instance, e.g., a single namespace of shares, files and folders, for each file server instance. However, the shares, files, and folders in a file server instance such as FS1 may actually be distributed across multiple FSVMs 720 and 722. For example, different folders in the same file server instance may be associated with different corresponding FSVMs 720 and 722 and CVMs 724 and 726 on different host machines 704 and 706.

The example file server instance FS1 604 shown in FIG. 6 has two shares, Share-1 608 and Share-2 610. Share-1 608 may be located on FSVM-1 720, CVM-1 724, and local storage 728. Network file system protocol requests from user VMs to read or write data on file server instance FS1 604 and any share, folder, or file in the instance may be sent to FSVM-1 720. FSVM-1 720 (or another component, such as a hypervisor in some examples) may determine whether the requested data, e.g., the share, folder, file, or a portion thereof, referenced in the request, is located on FSVM-1 720, and FSVM-1 720 is a leader for the requested data. If not, FSVM-1 720 may respond to the requesting user VM with an indication that the requested data is not covered by (e.g., is not located on or served by) FSVM-1. Otherwise, the requested data is covered by (e.g., is located on or served by) FSVM-1 720, so FSVM-1 720 may send iSCSI protocol requests to a CVM that is associated with the requested data. Note that the CVM associated with the requested data may be the CVM-1 724 on the same host machine 704 as the FSVM-1 720, or a different CVM on a different host machine 706, depending on the configuration of the VFS. In this example, the requested Share-1 is located on FSVM-1 720, so FSVM-1 720 processes the request. To provide for path availability, multipath I/O (MPIO) may be used for communication with the FSVM, e.g., for communication between FSVM-1 720 and CVM-1 724. The active path may be set to the CVM that is local to the FSVM (e.g., on the same host machine) by default. The active path may be set to a remote CVM instead of the local CVM, e.g., when a failover occurs.

Continuing with the data request example, the associated CVM is CVM-1 724, which may in turn access the storage device associated with the requested data as specified in the request, e.g., to write specified data to the storage device or read requested data from a specified location on the storage device. In this example, the associated storage device is in local storage 728, and may be an HDD or SSD. CVM-1 724 may access the HDD or SSD via an appropriate protocol, e.g., iSCSI, SCSI, SATA, or the like. CVM 110a may send the results of accessing local storage 728, e.g., data that has been read, or the status of a data write operation, to CVM 724 via, e.g., SATA, which may in turn send the results to FSVM-1 720 via, e.g., iSCSI. FSVM-1 720 may then send the results to the user VM via SMB through the hypervisor 716.

Share-2 610 may be located on FSVM-2 722, on Host-2. Network file service protocol requests from user VMs to read or write data on Share-2 may be directed to FSVM-2 722 on Host-2 by other FSVMs. Alternatively, user VMs may send such requests directly to FSVM-2 722 on Host-2, which may process the requests using CVM-2 726 and local storage 730 on Host-2 as described above for FSVM-1 720 on Host-1.

A file server instance such as FS1 604 in FIG. 6 may appear as a single file system instance (e.g., a single namespace of folders and files that are accessible by their names or pathnames without regard for their physical locations), even though portions of the file system are stored on different host machines. Since each FSVM may provide a portion of a file server instance, each FSVM may have one or more “local” file systems that provide the portion of the file server instance (e.g., the portion of the namespace of files and folders) associated with the FSVM.

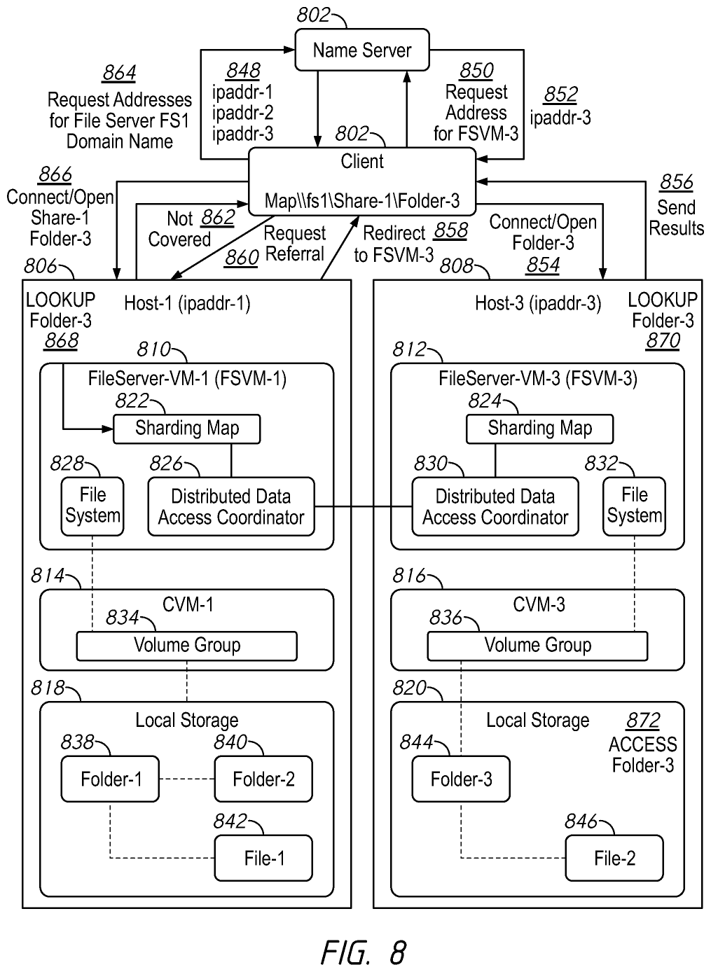

FIG. 8 illustrates example interactions between a client 804 and host machines 806 and 808 on which different portions of a VFS instance are stored according to particular embodiments. A client 804, e.g., an application program executing in one of the user VMs and on the host machines of a virtualized file server described herein requests access to a folder WFS1.domain.name\Share-1\Folder-3. The request may be in response to an attempt to map \FS1.domain.name\Share-1 to a network drive in the operating system executing in the user VM followed by an attempt to access the contents of Share-1 or to access the contents of Folder-3, such as listing the files in Folder-3.

FIG. 8 shows interactions that occur between the client 804, FSVMs 810 and 812 on host machines 806 and 808, and a name server 802 when a storage item is mapped or otherwise accessed. The name server 802 may be provided by a server computer system, such as one or more of the host machines 806, 808 or a server computer system separate from the host machines 806, 808. In one example, the name server 802 may be provided by an ACTIVE DIRECTORY service executing on one or more computer systems and accessible via the network. The interactions are shown as arrows that represent communications, e.g., messages sent via the network. Note that the client 804 may be executing in a user VM, which may be co-located with one of the FSVMs 810 and 812. In such a co-located case, the arrows between the client 804 and the host machine on which the FSVM is located may represent communication within the host machine, and such intra-host machine communication may be performed using a mechanism different from communication over the network, e.g., shared memory or inter-process communication.

In particular embodiments, when the client 804 requests access to Folder-3, a VFS client component executing in the user VM may use a distributed file system protocol such as MICROSOFT DFS, or the like, to send the storage access request to one or more of the FSVMs of FIGS. 3-4. To access the requested file or folder, the client determines the location of the requested file or folder, e.g., the identity and/or network address of the FSVM on which the file or folder is located. The client may query a domain cache of FSVM network addresses that the client has previously identified (e.g., looked up). If the domain cache contains the network address of an FSVM associated with the requested folder name \FS1.domain.name\Share-1\Folder-3, then the client retrieves the associated network address from the domain cache and sends the access request to the network address, starting at step 864 as described below.

In particular embodiments, at step 864, the client may send a request for a list of addresses of FSVMs to a name server 802. The name server 802 may be, e.g., a DNS server or other type of server, such as a MICROSOFT domain controller (not shown), that has a database of FSVM addresses. At step 848, the name server 802 may send a reply that contains a list of FSVM network addresses, e.g., ip-addr1, ip-addr2, and ip-addr3, which correspond to the FSVMs in this example. At step 866, the client 804 may send an access request to one of the network addresses, e.g., the first network address in the list (ip-addr1 in this example), requesting the contents of Folder-3 of Share-1. By selecting the first network address in the list, the particular FSVM to which the access request is sent may be varied, e.g., in a round-robin manner by enabling round-robin DNS (or the like) on the name server 802. The access request may be, e.g., an SMB connect request, an NFS open request, and/or appropriate request(s) to traverse the hierarchy of Share-1 to reach the desired folder or file, e.g., Folder-3 in this example.

At step 868, FileServer-VM-1 (FSVM-1) 810 may process the request received at step 866 by searching a mapping or lookup table, such as a sharding map 822, for the desired folder or file. The map 822 maps stored objects, such as shares, folders, or files, to their corresponding locations, e.g., the names or addresses of FSVMs. The map 822 may have the same contents on each host machine, with the contents on different host machines being synchronized using a distributed data store as described below. For example, the map 822 may contain entries that map Share-1 and Folder-1 to the File Server FSVM-1 810, and Folder-3 to the File Server FSVM-3 812. An example map is shown in Table 1 below. While the example of FIG. 8 is depicted and described with respect to the FSVM processing the request, in some examples, one or more other components of a virtualized system may additionally or instead process the request (e.g., a CVM and/or a hypervisor).

| Stored Object | Location |
|---|---|
| Folder-1 | FSVM-1 |
| Folder-2 | FSVM-1 |
| File-1 | FSVM-1 |
| Folder-3 | FSVM-3 |
| File-2 | FSVM-3 |

In particular embodiments, the map 822 or 824 may be accessible on each of the host machines. The maps may be copies of a distributed data structure that are maintained and accessed at each FSVM using distributed data access coordinators 826 and 830. The distributed data access coordinators 826 and 830 may be implemented based on distributed locks or other storage item access operations. Alternatively, the distributed data access coordinators 826 and 830 may be implemented by maintaining a master copy of the maps 822 and 824 at a leader node such as the host machine 808, and using distributed locks to access the master copy from each of FSVM 810 and 812. The distributed data access coordinators 826 and 830 may be implemented using distributed locking, leader election, or related features provided by a centralized coordination service for maintaining configuration information, naming, providing distributed synchronization, and/or providing group services (e.g., APACHE ZOOKEEPER or other distributed coordination software). Since the map 822 indicates that Folder-3 is located at FSVM-3 812 on Host-3 808, the lookup operation at step 868 determines that Folder-3 is not located at FSVM-1 on Host-1 806. Thus, at step 862 the FSVM-1 810 (or other component of the virtualized system) sends a response, e.g., a “Not Covered” DFS response, to the client 804 indicating that the requested folder is not located at FSVM-1. At step 860, the client 804 sends a request to FSVM-1 for a referral to the FSVM on which Folder-3 is located. FSVM-1 uses the map 822 to determine that Folder-3 is located at FSVM-3 on Host-3 808, and at step 858 returns a response, e.g., a “Redirect” DFS response, redirecting the client 804 to FSVM-3. The client 804 may then determine the network address for FSVM-3, which is ip-addr3 (e.g., a host name “ip-addr3.domain.name” or an IP address, 10.1.1.3). The client 804 may determine the network address for FSVM-3 by searching a cache stored in memory of the client 804, which may contain a mapping from FSVM-3 to ip-addr3 cached in a previous operation. If the cache does not contain a network address for FSVM-3, then at step 850 the client 804 may send a request to the name server 802 to resolve the name for FSVM-3. The name server may respond with the resolved address, ip-addr3, at step 852. The client 804 may then store the association between FSVM-3 and ip-addr3 in the client's cache.

In particular embodiments, failure of FSVMs may be detected using the centralized coordination service. For example, using the centralized coordination service, each FSVM may create a lock on the host machine on which the FSVM is located using ephemeral nodes of the centralized coordination service (which are different from host machines but may correspond to host machines). Other FSVMs may volunteer for leadership of resources of remote FSVMs on other host machines, e.g., by requesting a lock on the other host machines. The locks requested by the other nodes are not granted unless communication to the leader host machine is lost, in which case the centralized coordination service deletes the ephemeral node and grants the lock to one of the volunteer host machines, which becomes the new leader. For example, the volunteer host machines may be ordered by the time at which the centralized coordination service received their requests, and the lock may be granted to the first host machine on the ordered list. The first host machine on the list may thus be selected as the new leader. The FSVM on the new leader has ownership of the resources that were associated with the failed leader FSVM until the failed leader FSVM is restored, at which point the restored FSVM may reclaim the local resources of the host machine on which it is located.

At step 854, the client 804 may send an access request to FSVM-3 812 at ip-addr3 on Host-3 808 requesting the contents of Folder-3 of Share-1. At step 870, FSVM-3 812 queries FSVM-3's copy of the map 824 using FSVM-3's instance of the distributed data access coordinator 830. The map 824 indicates that Folder-3 is located on FSVM-3, so at step 872 FSVM-3 accesses the file system 832 to retrieve information about Folder-3 844 and its contents (e.g., a list of files in the folder, which includes File-2 846) that are stored on the local storage 820. FSVM-3 may access local storage 820 via CVM-3 816, which provides access to local storage 820 via a volume group 836 that contains one or more volumes stored on one or more storage devices in local storage 820. At step 856, FSVM-3 may then send the information about Folder-3 and its contents to the client 804. Optionally, FSVM-3 may retrieve the contents of File-2 and send them to the client 804, or the client 804 may send a subsequent request to retrieve File-2 as needed.

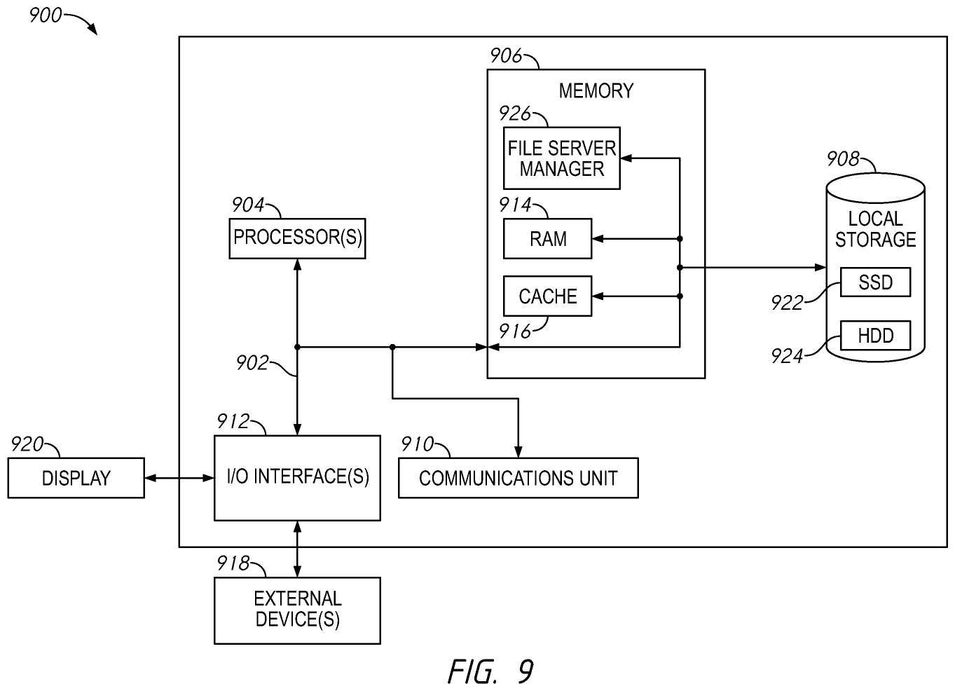

FIG. 9 depicts a block diagram of components of a computing system in accordance with examples described herein. It should be appreciated that FIG. 9 provides only an illustration of one implementation and does not imply any limitations with regard to the environments in which different embodiments may be implemented. Many modifications to the depicted environment may be made. The computing system may be used to implement and/or may be implemented by the file server manager 102 of FIG. 1, and/or one or more computing nodes of a virtualized file server, such as virtualized file server 106, virtualized file server 122, and/or virtualized file server 114 of FIG. 1, for example. The components shown in FIG. 9 are exemplary only, and it is to be understood that additional, fewer, and/or different components may be used in other examples.

The computing node 900 includes one or more communications fabric(s) 902, which provide communications between one or more processor(s) 904, memory 906, local storage 908, communications unit 910, and/or I/O interface(s) 912. The communications fabric(s) 902 can be implemented with any architecture designed for passing data and/or control information between processors (such as microprocessors, communications and network processors, etc.), system memory, peripheral devices, and any other hardware components within a system. For example, the communications fabric(s) 902 can be implemented with one or more buses.

The memory 906 and the local storage 908 may be computer-readable storage media. In the example of FIG. 9, the memory 906 includes random access memory (RAM) 914 and cache 916. In general, the memory 906 can include any suitable volatile or non-volatile computer-readable storage media. In this embodiment, the local storage 908 includes an SSD 922 and an HDD 924. The memory 906 may include executable instructions for providing a file server manager 926. The instructions for providing a file server manager 926 may be used to implement and/or be implemented by file server manager 102 of FIG. 1.

Various computer instructions, programs, files, images, etc., may be stored in local storage 908 and/or memory 906 for execution by one or more of the respective processor(s) 904 via one or more memories of memory 906. In some examples, local storage 908 includes a magnetic HDD 924. Alternatively, or in addition to a magnetic hard disk drive, local storage 908 can include the SSD 922, a semiconductor storage device, a read-only memory (ROM), an erasable programmable read-only memory (EPROM), a flash memory, or any other computer-readable storage media that is capable of storing program instructions or digital information.

The media used by local storage 908 may also be removable. For example, a removable hard drive may be used for local storage 908. Other examples include optical and magnetic disks, thumb drives, and smart cards that are inserted into a drive for transfer onto another computer-readable storage medium that is also part of local storage 908.

Communications unit 910, in some examples, provides for communications with other data processing systems or devices. For example, communications unit 910 may include one or more network interface cards. Communications unit 910 may provide communications through the use of either or both physical and wireless communications links.

I/O interface(s) 912 may allow for input and output of data with other devices that may be connected to computing node 900. For example, I/O interface(s) 912 may provide a connection to external device(s) 918 such as a keyboard, a keypad, a touch screen, and/or some other suitable input device. External device(s) can also include portable computer-readable storage media such as, for example, thumb drives, portable optical or magnetic disks, and memory cards. Software and data used to practice embodiments of the present invention can be stored on such portable computer-readable storage media and can be loaded onto and/or encoded in memory 906 and/or local storage 908 via I/O interface(s) 912 in some examples. I/O interface(s) 912 may connect to a display 920. Display 920 may provide a mechanism to display data to a user and may be, for example, a computer monitor.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A method comprising:
receiving, at a gateway of a management system configured to manage multiple file servers, an API call including an identified target file server;
preparing a request for an API permissions repository based on the identified target file server and a user;
receiving an API permission based on the user and the identified target file server from the permissions repository; and
allowing or declining the API call by the user in accordance with the API permission.

2. The method of claim 1, wherein said allowing or declining the API call comprises allowing the API call, and wherein the API call is for an action at the target file server.

3. The method of claim 2, further comprising routing the API call to the target file server based on an identification of the target file server.

4. The method of claim 3, wherein the identification comprises a URI or URL received with the API call.

5. The method of claim 1, further comprising storing associations between respective identifications of each of the multiple file servers and operation types expected at each of the multiple file servers.

6. The method of claim 1, further comprising providing a user interface for updating permissions in the API permissions repository.

7. The method of claim 6, further comprising:
receiving, through the user interface, a request to provide a first permission to a particular user; and
prompting, through the user interface, for authorization to provide a second permission to the particular user, wherein the first permission utilizes the second permission.

8. The method of claim 7, wherein the second permission comprises a network permission.

9. The method of claim 1, wherein the API permission comprises a role-based permission, and wherein the API permissions repository includes an association between the user and a role.

10. A system comprising:
a file server manager configured to manage multiple file servers, including a target file server, the file server manager including at least one non-transitory computer-readable media encoded with instructions for a gateway, the gateway configured to receive and route API calls;
the target file server, the target file server configured to provide access to at least one namespace of files; and
an API permissions repository configured to store associations between users, roles, file servers, and permissions for API calls;
wherein the file server manager is further configured to access the API permissions repository to request API permissions associated with a received API call for the target file server, and wherein the file server manager is configured to allow or decline the API call based on permissions information in the API permissions repository.

11. The system of claim 10, wherein the gateway is configured to route the received API call to the target file server based on identification of the target file server in the API call.

12. The system of claim 11, wherein the identification of the target file server comprises a URI or URL received with the API call.

13. The system of claim 10, wherein the API permissions repository includes stored associations between respective identifications of each of the multiple file servers and operation types expected at each of the multiple file servers.

14. The system of claim 10, wherein the gateway is further configured to provide a user interface for updating permissions in the API permissions repository.

15. The system of claim 14, wherein the gateway is configured to receive, through the user interface, a request to provide a first permission to a particular user; and prompt, through the user interface, for authorization to provide a second permission to the particular user, wherein the first permission utilizes the second permission.

16. The system of claim 15, wherein the second permission comprises a network permission.

17. At least one non-transitory computer-readable storage medium, the computer-readable storage medium encoded with instructions which, when executed, cause a system to perform operations comprising:
receive an API call including an identified target file server, the identified target file server being one of multiple file servers managed by a file server manager;
prepare a request for an API permissions repository based on the identified target file server and a user;
receive an API permission based on the user and the identified target file server from the permissions repository; and
allow or decline the API call by the user in accordance with the API permission.

18. The computer-readable storage medium of claim 17, wherein the instructions further configure the system to rout the API call to the target file server based on an identification of the target file server.

19. The computer-readable storage medium of claim 18, wherein the identification comprises a URI or URL received with the API call.

20. The computer-readable storage medium of claim 17, wherein the operations further comprise storing associations between respective identifications of each of the multiple file servers and operation types expected at each of the multiple file servers.

21. The computer-readable storage medium of claim 17, wherein the operations further comprise:
receiving, through a user interface, a request to provide a first permission to a particular user; and
prompt, through the user interface, for authorization to provide a second permission to the particular user, wherein the first permission utilizes the second permission.

22. The computer-readable storage medium of claim 21, wherein the second permission comprises a network permission.
